(19) United States
(12) Patent Application Publication
(10) Pub. No.: US 2026/0353044 A1
(43) Pub. Date: Nov. 5, 2026

(54) ENHANCEMENTS FOR WIRELESS FIDELITY (WI-FI) SENSING-BY-PROXY

(71) Applicant: QUALCOMM Incorporated, San Diego, CA (US)

(72) Inventors: Parthiban ELLAPPAN, Virudhunagar (IN); G SRIRAM, Karaikudi (IN); Akansh JAIN, Chennai (IN); Xiaoxin ZHANG, Sunnyvale, CA (US)

(21) Appl. No.: 19/197,691

(22) Filed: May 2, 2025

(51) Int. Cl. H04W 4/38; H04W 84/12

(52) U.S. Cl. CPC H04W 4/38; H04W 84/12

(57) ABSTRACT

In an aspect, a Wi-Fi requesting entity may determine a set of one or more Wi-Fi sensing entities from a plurality of Wi-Fi sensing entities for participation in a sensing session based on a set of one or more confidence metrics associated with each Wi-Fi sensing entity of the plurality of Wi-Fi sensing entities, wherein the set of one or more confidence metrics associated with each Wi-Fi sensing entity is indicative of an ability of the Wi-Fi sensing entity to provide reliable sensing measurements or sensing signal transmissions for sensing a target area during the sensing session. The Wi-Fi requesting entity may provide an indication of the set of one or more Wi-Fi sensing entities to a Wi-Fi responding entity.

### BACKGROUND OF THE DISCLOSURE

### 1. Field of the Disclosure

Aspects of the disclosure generally relate to wireless sensing in a Wi-Fi network and, more particularly, to enhancements to Wi-Fi sensing-by-proxy.

### 2. Description of the Related Art

Wi-Fi sensing may be employed in smart homes, security systems, healthcare monitoring, and industrial automation scenarios. Such sensing may be based on the emerging IEEE 802.11bf standard, which leverages wireless signals for perceiving objects in an environment by analyzing signal characteristic differences between Wi-Fi signals transmitted by Wi-Fi entities (e.g., Wi-Fi stations (STA), Wi-Fi access points (AP), etc.) and the Wi-Fi signals reflected by objects in the environment and received by such Wi-Fi entities. Wi-Fi sensing finds applications in motion detection, presence awareness, gesture recognition, and even respiration monitoring, all using a Wi-Fi network infrastructure.

### SUMMARY

In an aspect, a method performed by a Wi-Fi requesting entity includes determining a set of one or more Wi-Fi sensing entities from a plurality of Wi-Fi sensing entities for participation in a sensing session based on a set of one or more confidence metrics associated with each Wi-Fi sensing entity of the plurality of Wi-Fi sensing entities, wherein the set of one or more confidence metrics associated with each Wi-Fi sensing entity is indicative of an ability of the Wi-Fi sensing entity to provide reliable sensing measurements or sensing signal transmissions for sensing a target area during the sensing session; and providing an indication of the set of one or more Wi-Fi sensing entities to a Wi-Fi responding entity.

In an aspect, a method performed by a Wi-Fi responding entity includes receiving, from a Wi-Fi requesting entity, a sensing-by-proxy request to configure a sensing session to sense a target area; determining a set of one or more Wi-Fi sensing entities from a plurality of Wi-Fi sensing entities for participation in the sensing session based on a set of one or more confidence metrics associated with each Wi-Fi sensing entity of the plurality of Wi-Fi sensing entities, wherein the one or more confidence metrics associated with each Wi-Fi sensing entity is indicative of an ability of the Wi-Fi sensing entity to provide reliable sensing measurements for sensing the target area during the sensing session; and performing an action including at least one of configuring the set of one or more Wi-Fi sensing entities for participation in the sensing session, or sending a sensing report to the Wi-Fi requesting entity indicating the confidence metrics associated with each Wi-Fi sensing entity of the plurality of Wi-Fi sensing entities.

In an aspect, a Wi-Fi requesting entity includes one or more memories; one or more transceivers; and one or more processors communicatively coupled to the one or more memories and the one or more transceivers, the one or more processors, either alone or in combination, configured to: determine a set of one or more Wi-Fi sensing entities from a plurality of Wi-Fi sensing entities for participation in a sensing session based on a set of one or more confidence metrics associated with each Wi-Fi sensing entity of the plurality of Wi-Fi sensing entities, wherein the set of one or more confidence metrics associated with each Wi-Fi sensing entity is indicative of an ability of the Wi-Fi sensing entity to provide reliable sensing measurements or sensing signal transmissions for sensing a target area during the sensing session; and provide an indication of the set of one or more Wi-Fi sensing entities to a Wi-Fi responding entity.

In an aspect, a Wi-Fi requesting entity includes means for determining a set of one or more Wi-Fi sensing entities from a plurality of Wi-Fi sensing entities for participation in a sensing session based on a set of one or more confidence metrics associated with each Wi-Fi sensing entity of the plurality of Wi-Fi sensing entities, wherein the set of one or more confidence metrics associated with each Wi-Fi sensing entity is indicative of an ability of the Wi-Fi sensing entity to provide reliable sensing measurements or sensing signal transmissions for sensing a target area during the sensing session; and means for providing an indication of the set of one or more Wi-Fi sensing entities to a Wi-Fi responding entity.

In an aspect, a non-transitory computer-readable medium stores computer-executable instructions that, when executed by a Wi-Fi requesting entity, cause the Wi-Fi requesting entity to: determine a set of one or more Wi-Fi sensing entities from a plurality of Wi-Fi sensing entities for participation in a sensing session based on a set of one or more confidence metrics associated with each Wi-Fi sensing entity of the plurality of Wi-Fi sensing entities, wherein the set of one or more confidence metrics associated with each Wi-Fi sensing entity is indicative of an ability of the Wi-Fi sensing entity to provide reliable sensing measurements or sensing signal transmissions for sensing a target area during the sensing session; and provide an indication of the set of one or more Wi-Fi sensing entities to a Wi-Fi responding entity.

In an aspect, a Wi-Fi responding entity includes one or more memories; one or more transceivers; and one or more processors communicatively coupled to the one or more memories and the one or more transceivers, the one or more processors, either alone or in combination, configured to: receive, from a Wi-Fi requesting entity, a sensing-by-proxy request to configure a sensing session to sense a target area; determine a set of one or more Wi-Fi sensing entities from a plurality of Wi-Fi sensing entities for participation in the sensing session based on a set of one or more confidence metrics associated with each Wi-Fi sensing entity of the plurality of Wi-Fi sensing entities, wherein the one or more confidence metrics associated with each Wi-Fi sensing entity is indicative of an ability of the Wi-Fi sensing entity to provide reliable sensing measurements for sensing the target area during the sensing session; and perform an action including at least one of configure the set of one or more Wi-Fi sensing entities for participation in the sensing session, or send a sensing report to the Wi-Fi requesting entity indicating the confidence metrics associated with each Wi-Fi sensing entity of the plurality of Wi-Fi sensing entities.

In an aspect, a Wi-Fi responding entity includes means for receiving, from a Wi-Fi requesting entity, a sensing-by-proxy request to configure a sensing session to sense a target area; means for determining a set of one or more Wi-Fi sensing entities from a plurality of Wi-Fi sensing entities for participation in the sensing session based on a set of one or more confidence metrics associated with each Wi-Fi sensing entity of the plurality of Wi-Fi sensing entities, wherein the one or more confidence metrics associated with each Wi-Fi sensing entity is indicative of an ability of the Wi-Fi sensing entity to provide reliable sensing measurements for sensing the target area during the sensing session; and means for performing an action including at least one of; means for configuring the set of one or more Wi-Fi sensing entities for participation in the sensing session, or; and means for sending a sensing report to the Wi-Fi requesting entity indicating the confidence metrics associated with each Wi-Fi sensing entity of the plurality of Wi-Fi sensing entities.

In an aspect, a non-transitory computer-readable medium stores computer-executable instructions that, when executed by a Wi-Fi responding entity, cause the Wi-Fi responding entity to: receive, from a Wi-Fi requesting entity, a sensing-by-proxy request to configure a sensing session to sense a target area; determine a set of one or more Wi-Fi sensing entities from a plurality of Wi-Fi sensing entities for participation in the sensing session based on a set of one or more confidence metrics associated with each Wi-Fi sensing entity of the plurality of Wi-Fi sensing entities, wherein the one or more confidence metrics associated with each Wi-Fi sensing entity is indicative of an ability of the Wi-Fi sensing entity to provide reliable sensing measurements for sensing the target area during the sensing session; and perform an action including at least one of configuring the set of one or more Wi-Fi sensing entities for participation in the sensing session, or sending a sensing report to the Wi-Fi requesting entity indicating the confidence metrics associated with each Wi-Fi sensing entity of the plurality of Wi-Fi sensing entities.

### BRIEF DESCRIPTION OF THE DRAWINGS

The accompanying drawings are presented to aid in the description of various aspects of the disclosure and are provided solely for illustration of the aspects and not limitation thereof.

FIGS. 1A, 1B, and 1C are simplified block diagrams of several sample aspects of components that may be employed in a Wi-Fi entity, a Wi-Fi access point, and a network entity, according to aspects of the disclosure.

FIG. 2 shows an example Wi-Fi network system, according to aspects of the disclosure.

FIG. 3 shows example sensing-by-proxy frames and the corresponding parameter control fields, according to aspects of the disclosure.

FIG. 4 shows an example Wi-Fi sensing-by-proxy scenario, according to aspects of the disclosure.

FIG. 5 shows an example Sensing Measurement Report Container field, according to aspects of the disclosure.

FIG. 6 shows an example sensing environment in which the selection of Wi-Fi sensing entities may be based on diversity, according to aspects of the disclosure.

FIG. 7 shows an example sensing environment in which the selection of Wi-Fi sensing entities may be based on a Wi-Fi sensing mode of operation, according to aspects of the disclosure.

FIG. 8 is a method for dynamically adjusting the selection of the Wi-Fi sensing entities during a sensing-by-proxy positioning session, according to aspects of the disclosure.

FIG. 9 shows a method performed by a Wi-Fi requesting entity, according to aspects of the disclosure.

FIG. 10 shows a method performed by a Wi-Fi responding entity, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application-specific integrated circuits (ASICs)), program instructions executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

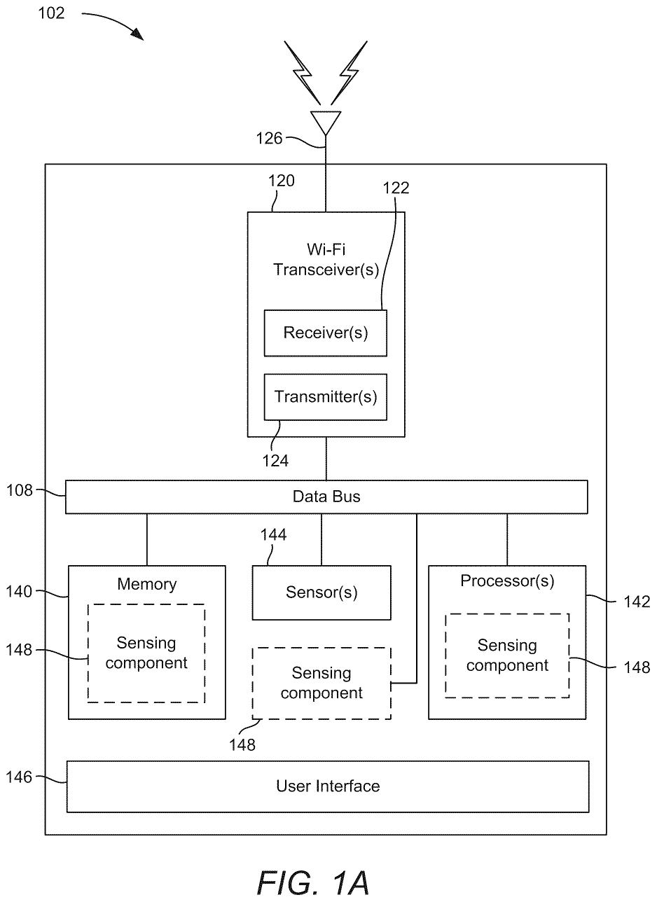

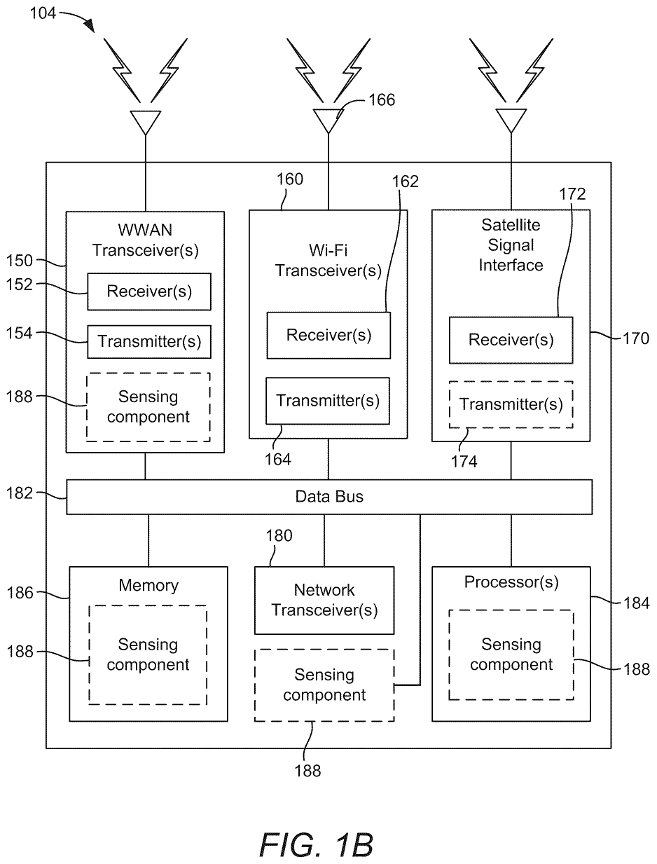

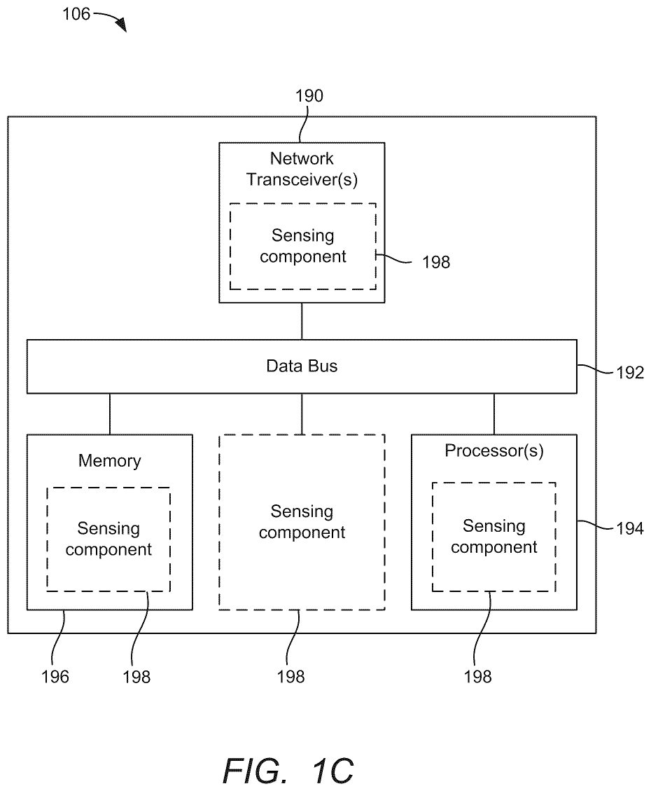

FIGS. 1A, 1B, and 1C illustrate several example components (represented by corresponding blocks) that may be incorporated into a Wi-Fi station 102 (which may correspond to any of the Wi-Fi stations/Wi-Fi sensing entities described herein), a Wi-Fi access point 104 (which may correspond to any of the access points/Wi-Fi responding entities described herein), and a network entity 106 (which may correspond to or embody any of the network functions described herein, including a sensing management function (SMF)) to support the Wi-Fi sensing operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The Wi-Fi station 102 and the Wi-Fi access point 104 may each include one or more (W-FI) transceivers 120 and 160, respectively. The Wi-Fi transceivers 120 and 160 may be connected to one or more antennas 126 and 166, respectively, and provide means for communicating (e.g., means for transmitting, means for receiving, means for measuring, means for tuning, means for refraining from transmitting, etc.) with other network nodes, such as other Wi-Fi entities and/or Wi-Fi AP via at least one designated Radio Access Technology (RAT) (e.g., Wi-Fi) over a wireless communication medium of interest. The Wi-Fi transceivers 120 and 160 may be variously configured for transmitting and encoding signals (e.g., messages, indications, information, and so on), respectively, and, conversely, for receiving and decoding signals (e.g., messages, indications, information, pilots, and so on), respectively, in accordance with the designated RAT. Specifically, the Wi-Fi transceivers 120 and 160 may include one or more transmitters 124 and 164, respectively, for transmitting and encoding signals and one or more receivers 122 and 162 for receiving and decoding the signals.

The Wi-Fi access point 104 may include, at least in some cases, a satellite signal interface 170, which includes one or more satellite signal receivers 172, and may optionally include one or more satellite signal transmitters 174. In some cases, the Wi-Fi access point 104 may be a terrestrial base station that may communicate with satellite positioning system receivers, the satellite positioning/communication signals may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver 172 is a non-terrestrial network (NTN) receiver, the satellite positioning/communication signals may be communication signals (e.g., carrying control and/or user data) originating from a 5G network. The satellite signal receiver 172 may comprise any suitable hardware and/or software for receiving and processing satellite positioning/communication signals. The satellite signal receiver 172 may request information and operations as appropriate from the other systems and, at least in some cases, perform calculations to determine the location of the Wi-Fi access point 104, using measurements obtained by any suitable satellite positioning system algorithm.

The Wi-Fi access point 104 and the network entity 106 may each include one or more network transceivers 180 and 190, respectively, providing means for communicating (e.g., means for transmitting, means for receiving, etc.) with other Wi-Fi APs 104 and/or other network entities 106. For example, the Wi-Fi access point 104 may employ the one or more network transceivers 180 to communicate with other Wi-Fi APs 104 or network entities 106 over one or more wired or wireless links. As another example, the network entity 106 may employ the one or more network transceivers 190 to communicate with one or more Wi-Fi APs 104 over one or more wired or wireless links, or with other network entities 106 over one or more wired or wireless core network interfaces.

The Wi-Fi station 102, the Wi-Fi access point 104, and the network entity 106 may also include other components that may be used in conjunction with the operations disclosed herein. The Wi-Fi station 102, the Wi-Fi access point 104, and the network entity 106 may include one or more processors 142, 184, and 194, respectively, for providing functionality relating to, for example, wireless communication and sensing, and for providing other processing functionality. The processors 142, 184, and 194 may, therefore, provide means for processing, such as means for determining, means for calculating, means for receiving, means for transmitting, means for indicating, etc. In an aspect, the processors 142, 184, and 194 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The Wi-Fi station 102, the Wi-Fi access point 104, and the network entity 106 may include memory circuitry implementing memories 140, 186, and 196 (e.g., each including a memory device), respectively, for maintaining information (e.g., information indicative of reserved resources, thresholds, parameters, and so on). The memories 140, 186, and 196 may, therefore provide means for storing, means for retrieving, means for maintaining, etc. In some cases, the Wi-Fi station 102, the Wi-Fi access point 104, and the network entity 106 may include a sensing component 148, 188, and 198, respectively. The sensing components 148, 188, and 198 may be hardware circuits that are part of or coupled to the processors 142, 184, and 194, respectively, that, when executed, cause the Wi-Fi station 102, the Wi-Fi access point 104, and the network entity 106 to perform the functionality described herein. In other aspects, the sensing components 148, 188, and 198 may be external to the processors 142, 184, and 194 (e.g., part of a modem processing system, integrated with another processing system, etc.). Alternatively, the sensing components 148, 188, and 198 may be memory modules stored in the memories 140, 186, and 196, respectively, that, when executed by the processors 142, 184, and 194 (or a modem processing system, another processing system, etc.), cause the Wi-Fi station 102, the Wi-Fi access point 104, and the network entity 106 to perform the functionality described herein. FIG. 1A illustrates possible locations of the sensing component 148, which may be, for example, part of the memory 140, the one or more processors 142, or any combination thereof, or may be a standalone component. FIG. 1B illustrates possible locations of the sensing component 188, which may be, for example, part of the one or more WWAN transceivers 150, the memory 186, the one or more processors 184, or any combination thereof, or may be a standalone component. FIG. 1C illustrates possible locations of the sensing component 198, which may be, for example, part of the one or more network transceivers 190, the memory 196, the one or more processors 194, or any combination thereof, or may be a standalone component.

The Wi-Fi station 102 may include one or more sensors 144 coupled to the one or more processors 142 to provide means for sensing or detecting movement and/or orientation information that is independent of motion data derived from signals received by the one or more Wi-Fi transceivers 120. By way of example, the sensor(s) 144 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 144 may include a plurality of different types of devices and combine their outputs to provide motion information. For example, the sensor(s) 144 may use a combination of a multi-axis accelerometer and orientation sensors to provide the ability to compute positions in two-dimensional (2D) and/or three-dimensional (3D) coordinate systems.

In addition, the Wi-Fi station 102 may include a user interface 146 providing means for providing indications (e.g., audible and/or visual indications) to a user and/or for receiving user input (e.g., upon user actuation of a sensing device such a keypad, a touch screen, a microphone, and so on). Although not shown, the Wi-Fi access point 104 and the network entity 106 may also include user interfaces.

For convenience, the Wi-Fi station 102, the Wi-Fi access point 104, and/or the network entity 106 are shown in FIGS. 1A, 1B, and 1C as including various components that may be configured according to the various examples described herein. It will be appreciated, however, that the illustrated components may have different functionality in different designs. In particular, various components in FIGS. 1A to 1C are optional in alternative configurations and the various aspects include configurations that may vary due to design choice, costs, use of the device, or other considerations. For example, in the case of FIG. 1A, a particular implementation of Wi-Fi station 102 may omit the WWAN transceiver(s) 110 (e.g., a wearable device or tablet computer or personal computer (PC) or laptop may have Wi-Fi and/or BLUETOOTH® capability without cellular capability), or may omit the Wi-Fi transceiver(s) 120 (e.g., cellular-only, etc.), or may omit the satellite signal interface 130, or may omit the sensor(s) 144, and so on. In another example, in the case of FIG. 1B, a particular implementation of the Wi-Fi access point 104 may omit the WWAN transceiver(s) 150 (e.g., a Wi-Fi “hotspot” access point without cellular capability), or may omit the Wi-Fi transceiver(s) 160 (e.g., cellular-only, etc.), or may omit the satellite signal interface 170, and so on. For brevity, an illustration of the various alternative configurations is not provided herein, but would be readily understandable to one skilled in the art.

The components of FIGS. 1A, 1B, and 1C may be implemented in various ways. In some implementations, the components of FIGS. 1A, 1B, and 1C may be implemented in one or more circuits, such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 140 to 146 may be implemented by processor and memory component(s) of the Wi-Fi station 102 (e.g., by execution of appropriate code and/or by appropriate configuration of processor components). Similarly, some or all of the functionality represented by blocks 150 to 188 may be implemented by processor and memory component(s) of the Wi-Fi access point 104 (e.g., by execution of appropriate code and/or by appropriate configuration of processor components). Also, some or all of the functionality represented by blocks 190 to 198 may be implemented by processor and memory component(s) of the network entity 106 (e.g., by execution of appropriate code and/or by appropriate configuration of processor components).

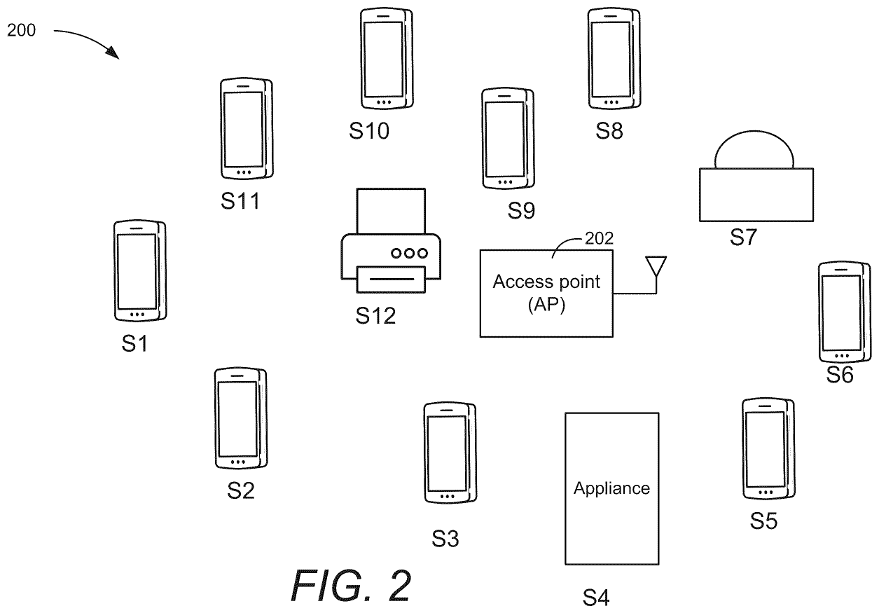

FIG. 2 shows an example Wi-Fi network system 200, according to aspects of the disclosure. In this example, the Wi-Fi network system 200 includes twelve Wi-Fi stations (labeled S1 through S12) and a Wi-Fi access point 202. Here, Wi-Fi station S4 is shown as an appliance (e.g., refrigerator, furnace, air-conditioner, etc.) with Wi-Fi station capabilities. Wi-Fi station S7 is shown as a camera, motion detector, or other sensor type with Wi-Fi station capabilities. Still further, Wi-Fi station S12 is shown as a computer peripheral (e.g., printer, facsimile machine, copier, etc.) having Wi-Fi station capabilities.

IEEE 802.11bf is an evolving Wi-Fi network standard that includes proposed standards for Wi-Fi sensing. Certain aspects of the standard are directed to Wi-Fi sensing-by-proxy (SBP). In the IEEE 802.11bf standard, SBP enables a Wi-Fi station (e.g., Wi-Fi requesting entity) to request a Wi-Fi access point (e.g., Wi-Fi responding entity) to perform sensing operations on its behalf. In an aspect, the Wi-Fi responding entity configures the Wi-Fi sensing entities (e.g., Wi-Fi stations (STA)) that will be used for the Wi-Fi SBP session. Wi-Fi SBP is particularly useful when the Wi-Fi requesting entity lacks the capability or optimal positioning to conduct effective Wi-Fi sensing measurements independently.

In a Wi-Fi sensing-by-proxy session, the Wi-Fi requesting entity may transmit an SBP Request frame to the Wi-Fi responding entity. The SBP Request frame may include an SBP Parameters Control field. The Wi-Fi responding entity may transmit an SBP Response frame, including an SBP Parameters Control field.

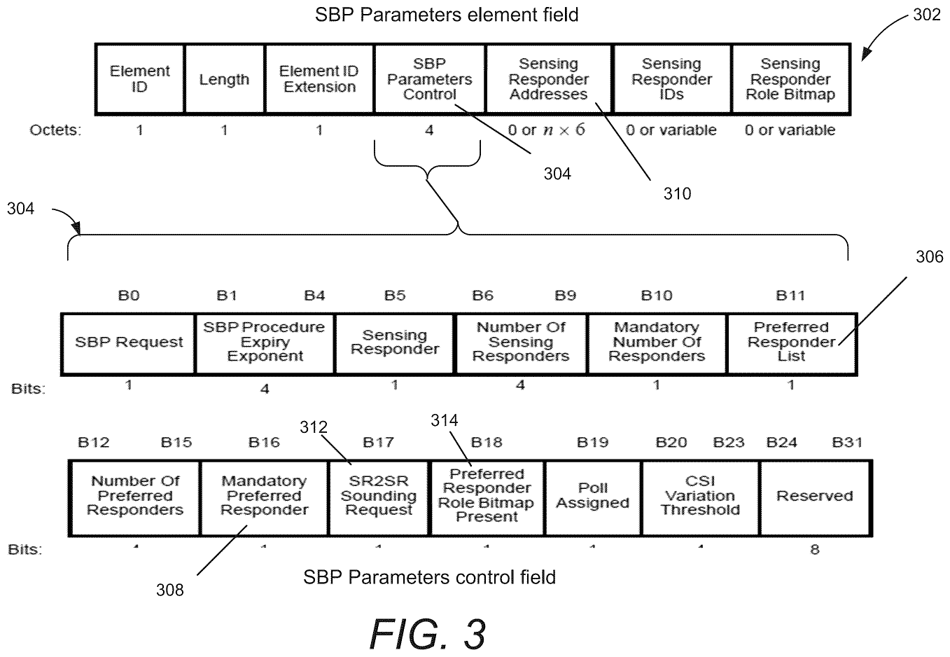

FIG. 3 shows example sensing-by-proxy frames and the corresponding parameter control fields, according to aspects of the disclosure. In FIG. 3, the example SBP Parameters Element frame 302 includes an example SBP Parameters Control field 304.

As shown in FIG. 3, Bits B24 to B31 in the SBP Parameters Control field 304 are reserved. According to aspects of the disclosure, the Wi-Fi requesting entity and Wi-Fi responding entity can repurpose some of these reserved bits to indicate additional information for Wi-Fi SBP scenarios. In an aspect, the Wi-Fi requesting entity may use one or more of the reserved bits to indicate a Wi-Fi sensing mode that may impose specific Wi-Fi sensing criteria for a Wi-Fi SBP session. For example, the Wi-Fi requesting entity may use one or more bits to indicate that the Wi-Fi SBP session is to be executed in accordance with the criterion associated with a “Vacation Mode,” where whole-house sensing is requested. In an aspect, the Wi-Fi responding entity can use one or more bits to confirm that “Vacation Mode” has been enabled for the Wi-Fi SBP session. In an aspect, such modes may provide an indication of the desired location diversity of the Wi-Fi sensing entities that are selected for the Wi-Fi sensing session.

In another example, the Wi-Fi requesting entity may use multiple bits to indicate various levels of the “Required Sensing Quality” and one or more bits bit to indicate whether the Wi-Fi responding entity is allowed to add new Wi-Fi sensing entities as set forth herein. Similarly, the Wi-Fi responding entity may employ some of the reserved bits to confirm such settings.

As shown in FIG. 3, the SBP Parameters Control field 304 may include a Preferred Responder List field 306 and a Mandatory Preferred Responder List field 308. According to aspects of the disclosure, the Preferred Responder List field 306 and the Mandatory Preferred Responder List field 308 may be used to indicate the method that the Wi-Fi responding entity uses to determine the Wi-Fi sensing entities that are to participate in the Wi-Fi SBP session requested by the Wi-Fi requesting entity. When the Preferred Responder List field 306 is set to 0, the Wi-Fi responding entity may choose any Wi-Fi sensing stations for participation in the Wi-Fi SBP session. When both the Preferred Responder List field 306 and the Mandatory Preferred Responder List 308 are set to 1, the Wi-Fi responding entity selects the Wi-Fi sensing entities for participation in the Wi-Fi sensing-by-proxy session from the medium access control (MAC) addresses listed in the Sensing Responder Addresses field 310 of the SBP Parameters Element frame 302. In an aspect, the state of the Preferred Responder List field 306 and the Mandatory Preferred Responder List field 308 may signaled in a Medium Access Control Layer Management Entity (MLME) sensing-by-proxy primitive.

If the Preferred Responder List field 306 and the Mandatory Preferred Responder List field 308 are both set to 1, the Wi-Fi requesting entity can provide the list of devices and role of devices (transmitter and/or receiver) for the sensing session in the Sensing Responder Addresses field 310. Although the Wi-Fi requesting entity may send a preferred list of Wi-Fi sensing entities for use in the Wi-Fi SBP session, the list of Wi-Fi sensing entities may not be optimal for dynamically varying sensing environments and may impact the sensing performance (e.g., the preferred Wi-Fi sensing entities) at time t1 might not be insightful/relevant at time t2 in a dynamic sensing environment, particularly in environments in which one or more of the Wi-Fi sensing entities are mobile.

Certain aspects of the disclosure recognize that the particular method used by the Wi-Fi responding entity to select the Wi-Fi sensing entities to be included in the sensing session when the Preferred Responder List field 306 is set to 0 or in which the Preferred Responder List field 306 is set to 1, and the Mandatory Preferred Responder List 308 is set to 0 may be implementation dependent. Accordingly, certain aspects of the disclosure are directed to the various manners in which the preferred list of Wi-Fi sensing entities and/or the number of Wi-Fi sensing entities that participate in a Wi-Fi SBP session are determined. In an aspect, the number and location of the Wi-Fi sensing entities in the sensing environment may be considered in determining which of the Wi-Fi sensing entities may be used to meet the sensing performance specifications associated with the Wi-Fi SBP session. For example, performing a Wi-Fi SBP session with a large number of Wi-Fi sensing entities that are necessary may impose higher transmission power requirements on the session while not adding useful sensing information. Conversely, using fewer Wi-Fi sensing entities than necessary may result in gaps in sensing coverage.

Certain aspects of the disclosure are based on the selection of the Wi-Fi sensing entities by the Wi-Fi responding entity (e.g., SBP responder-based selection). In sensing scenarios in which the Preferred Responder List field is set to 0, the Wi-Fi responding entity (e.g., Wi-Fi access point) may determine which of a plurality of Wi-Fi sensing entities will be employed in the Wi-Fi SBP session based on a set of confidence metrics respectively associated with each Wi-Fi sensing entity. In an aspect, the set of one or more confidence metrics associated with each Wi-Fi sensing entity may be indicative of the ability of the Wi-Fi sensing entity to provide reliable sensing measurements or sensing signal transmissions for sensing the target object during the sensing session. In an aspect, the confidence metrics may be determined by one or both the Wi-Fi requesting entity and the responding Wi-Fi entity based on the particular sensing scenario.

Various factors may be used to assess a set of confidence metrics for a Wi-Fi sensing entity. Examples of such factors include:
The dynamic nature of the Wi-Fi sensing entity—This factor includes, for example, whether the Wi-Fi sensing entity is currently moving or stationary. Smart appliances and mobile devices in their charging stations may be considered stationary, while mobile devices moving within the sensing environment may be considered dynamic. In an aspect, Wi-Fi devices with a fixed location (Static), such as printers, washers, cameras, and mobile devices in their charging stations can be preferred as easier to track and maintain confidence metrics such as received signal strength indicator (RSSI), round-trip-time (RTT), angle-of-arrival (AoA). When a Wi-Fi device is moving, the access point may have to frequently track RSSI, RTT, and AoA to accurately determine the confidence metrics of the Wi-Fi responding entities.
The location of the Wi-Fi sensing entity—This factor includes, for example, the absolute coordinates and relative distance of the Wi-Fi sensing entity. In an aspect, the location of the Wi-Fi sensing entity is known and need not be subject to wireless positioning determinations. In an aspect, a smaller distance between the Wi-Fi requesting entity and the Wi-Fi responding entity may be associated with a higher confidence level compared to larger distances between such entities.
The channel conditions associated with the Wi-Fi sensing entity (e.g., channel conditions between the Wi-Fi requesting entity and Wi-Fi responding entity)—Channel conditions may include whether the channel path is a line-of-sight (LoS) or Non-Line-of-Sight (NLoS) path, where LoS paths are preferable. Channel conditions may also include whether the channel is multipath-rich or only subject to low scattering, where low scattering channels are preferable. Channel conditions may also include whether the channel is fast fading or slow fading, where slow fading is preferable.
The packet bandwidth capabilities of the Wi-Fi sensing entity—The desired bandwidth capabilities of the Wi-Fi sensing entity (e.g., 20/40/80/160/320 MHz) may be dependent on the sensing session requirements. In some scenarios, higher bandwidth capabilities may be desired, while the sensing requirements in other scenarios may be met by Wi-Fi sensing entities having lower bandwidth capabilities.
The power capabilities at the Wi-Fi sensing entity—This factor may include whether the Wi-Fi sensing entity is fully charged, partially charged, or connected to shore power. This factor may also include the transmission power capabilities and processing power constraints of the Wi-Fi sensing entity.
The estimated location parameters associated with the Wi-Fi sensing entity—The estimated location parameters may be obtained from any location technologies including, but not limited to, received signal strength indication-based (RSSI-based), range-based estimates (e.g., 802.11mc, 802.11az, 802.11bk) Range (11mc/11az/11bk), AoA estimates, angle-of-departure (AoD) estimates, RTT estimates, etc. In an aspect, the estimated location parameters are obtained between the Wi-Fi requesting entity and the Wi-Fi sensing entity. In an aspect, a higher RSSI is associated with a greater confidence level compared to a lower RSSI. Likewise, a lower RTT measurement (e.g., shorter distance) is associated with a greater confidence level compared to a higher RTT measurement (e.g., greater distance).
Error estimates associated with the Wi-Fi sensing entity—Error estimates may include whether the errors are based on a standard deviation determination, peak-to-peak variation, or yield. In accordance with various aspects of the disclosure, the measured errors may be based on true distance or may be statistical. For example, an error metric may be obtained from standard deviation, mean error, etc. Peak-to-peak variations denote error variations across time or packets. Yield determinations may denote the percentage of successful packet transmissions and receptions.
Radio Access Technology (RAT) Availability of the Wi-Fi sensing entity—This factor may be considered for data throughput specifications for the sensing session. The factor may include the RAT busy or RAT idle percentage associated with the Wi-Fi sensing entity.

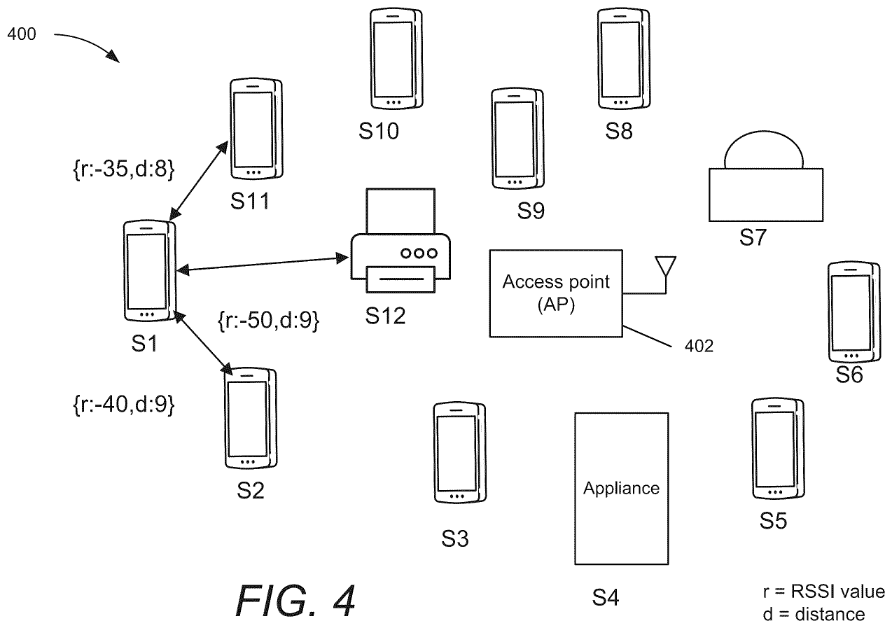

FIG. 4 shows an example Wi-Fi SBP scenario 400, according to aspects of the disclosure. Scenario 400 is based on the selection of the Wi-Fi sensing entities by the Wi-Fi responding entity. In scenario 400, there are multiple Wi-Fi sensing entities (STAs) available, labeled S1 through S12. Here, the Wi-Fi access point 402 (acting as the Wi-Fi responding entity) receives a sensing-by-proxy request from S1 (acting as the Wi-Fi requesting entity) with the Preferred Responder List field set to 0. Under such circumstances, the Wi-Fi access point 402 may use the confidence metrics associated with each of the STAs S2 through S12 to determine which STAs should participate in the Wi-Fi SBP session. Here, the Wi-Fi access point 402 generates confidence metrics for each STA and uses the confidence metrics to select which of the STAs are to be configured for the Wi-Fi SBP session. In FIG. 4, the Wi-Fi access point 402 may use the location information for each of the STAs as obtained from any location technologies (e.g., RSSI-based, 802.11mc/11az/11bk RTT-based, AoA-based or any combination thereof) and select the STAs for the Wi-Fi SBP session. Any Wi-Fi device with a fixed location (static), such as printers, washers, cameras, and mobile devices in a charging station can be preferred as they are easier to track and maintain confidence metrics. A higher RSSI associated with an STA indicates a greater confidence level than an STA with a lower RSSI. A static device (e.g., printer S12 and appliance S4) is associated with a higher confidence metric than a mobile device. A LoS channel offers a higher confidence metric than a NLoS channel. A multipath light channel provides a higher confidence level than a multipath-rich channel. Each factor may be assigned a weight when determining the confidence metric for an STA. Here, the Wi-Fi access point 402 has selected STAs S12, S2, S11, and S10 for participation in the Wi-Fi SBP session.

In an aspect, the Wi-Fi access point 402 can sense the environment and monitor the validity of the sensing parameters. In an aspect, the Wi-Fi access point 402 may track the channel coherence time for each STA and determine the necessary frequency for sensing. This approach enhances sensing performance in a dynamically changing environment.

The Wi-Fi access point 402 can dynamically select and reassign the optimal set of STAs for a sensing scenario by periodically tracking the factors used in determining the confidence metrics. In an aspect, the Wi-Fi access point 402 may determine the sufficient and optimal number of STAs required for sensing and configure a Wi-Fi SBP session with the selected STAs. The number of STAs can be chosen based on a threshold set for the confidence metric. For example, as shown in FIG. 4, thresholds for selecting an STA can be based on RSSI and distance measurements. The Wi-Fi access point 402 might suggest a set of selected STAs, such as {S12, S2, S11} while excluding S10 due to its distance exceeding a certain threshold. In an aspect, the Wi-Fi requesting entity may specify the required quality of a sensing report by indicating it in this reserved field in the Parameters Control Field in the SBP Request frame.

In an example sensing scenario, the Wi-Fi requesting entity (e.g., S1) may transmit an SBP Request in which the Preferred Responder List field is set to 1 and the Mandatory Preferred Responder List is set to 0. In this scenario, the Wi-Fi requesting entity may send a list of the preferred Wi-Fi sensing entities using their MAC addresses and their respective roles in the SBP Parameters frame. The Wi-Fi responding entity (e.g., access point 402) may select a subset of these MAC addresses and include them in the SBP Response frame.

As noted, the manner in which the Wi-Fi responding entity selects the Wi-Fi sensing entities for the sensing session in this scenario is implementation dependent. In an aspect, the Wi-Fi responding entity may remove some existing Wi-Fi sensing entities from the preferred list and/or add new devices based on results from confidence metrics (e.g., RSSI-based, 802.11mc/11az/11bk, RTT-based, AoA-based or any combination thereof). The fact that the Wi-Fi responding entity has removed some of the preferred Wi-Fi sensing entities can be indicated in a reserved field (e.g., bit B25) of the SBP Parameters Control field in the SBP Response frame sent to the Wi-Fi requesting entity.

In an aspect, a reserved field (e.g., bit B24) may be used to indicate the quality of sensing required for the Wi-Fi SBP session when the Preferred Responder List is set to either 0 or 1, and the Preferred Responder List field is set to 0. For example, when the reserved field is set to 1, high-quality sensing may be needed, and, as such, the Wi-Fi responding entity can select a more significant number of Wi-Fi sensing entities to cover a larger sensing area with a higher sensing quality when compared to a low sensing quality session. When the reserved field is set to 0, the Wi-Fi responding entity may select the Wi-Fi sensing entities based on a standard set of rules that are not necessarily based on the sensing quality. The number of bits used in the reserved field may depend on the number of sensing quality levels to be employed.

In an aspect, the reserved field (e.g., B25) may be used to indicate whether the Wi-Fi responding entity can add or remove Wi-Fi sensing entities from the preferred list when the Preferred Responder List field is set to 1, and the Mandatory Preferred Responder List field is set to 0. When this reserved field (e.g., B25) is set to 1, the Wi-Fi responding entity can add Wi-Fi sensing entities beyond those indicated in the Preferred Responder List. When this reserved field is set to 0, the Wi-Fi responding entity cannot add further Wi-Fi sensing entities but may select a subset of the Wi-Fi sensing entities (e.g., remove some of the Wi-Fi sensing entities) indicated in the Preferred Responder List.

According to aspects of the disclosure, there are various methods for selecting Wi-Fi sensing entities when the Preferred Responder List field is set to 1, and the Mandatory Preferred Responder List field is set to 0. The first method views the Wi-Fi sensing entity selection from the perspective of the Wi-Fi requesting entity. With reference to FIG. 4, S1 may have confidence metrics for nearby STAs based on received packets, allowing it to select STAs for the sensing procedure based on higher RSSI or closer distance measurements. In an aspect, S1 can determine the relative distance to other STAs using RSSI-based, 802.11mc/11az/11bk, RTT-based, AoA-based measurements, or any combination thereof. Additionally, S1 may participate as a Proxy STA (PSTA) in passive Trigger-Based Ranging to determine its relative location with respect to S12, S3, and S11. Additionally, S1 may perform Non-Trigger-Based Ranging with S2 and S3 to determine its relative location. In an aspect, the ranging measurements may be based on RTT measurements, where a lower RTT measurement is associated with a higher confidence level than a larger RTT measurement.

A second method views the Wi-Fi sensing entity selection from the perspective of the Wi-Fi responding entity. With reference to FIG. 4, it is assumed that the Wi-Fi access point 402 (the Wi-Fi responding entity) has received an SBP Request from S1 (the Wi-Fi requesting entity). The SBP Parameters Element frame of the request includes the MAC addresses for S2, S5, S7, S12, and S11, indicating that these STAs are available for use as Wi-Fi sensing entities. In an aspect, the Wi-Fi access point 402 may determine the confidence metrics associated with each of the identified STAs to select which of the STAs will be configured for the sensing session (e.g., selecting S2, S12, and S11 while excluding S5 and S7). However, in certain scenarios, the Wi-Fi access point 402 may add S7 and S5 based on tracking their confidence metrics, such as their dynamic proximity to the target sensing area.

A third method views the Wi-Fi sensing entity selection from the perspective of both the Wi-Fi requesting entity and the Wi-Fi responding entity. In accordance with this method, the Wi-Fi requesting entity may select the Wi-Fi sensing entities for the positioning session based on confidence metrics associated with those Wi-Fi sensing entities. The Wi-Fi sensing entities selected by the Wi-Fi requesting entity may be identified in the sensing-by-proxy request sent to the Wi-Fi responding entity. In turn, the Wi-Fi responding entity may select which Wi-Fi sensing entities identified in the sensing-by-proxy request will be used for the sensing session based on the confidence metrics associated with each of the identified Wi-Fi sensing entities. In an aspect, the Wi-Fi responding entity may add further Wi-Fi sensing entities as needed to satisfy the sensing requirements of the sensing session. In an aspect, the set of confidence metrics used by the Wi-Fi requesting entity for selecting the Wi-Fi sensing entities may differ from the set of confidence metrics used by the Wi-Fi responding entity for its selection of the Wi-Fi sensing entities. In an aspect, the different sets of confidence metrics utilized may be based on confidence metrics obtained from different perspectives (e.g., some of the confidence metrics obtained from the perspective of the Wi-Fi requesting entity may be different than some of the confidence metrics obtained from the perspective of the Wi-Fi responding entity).

In some scenarios, the sensing-by-proxy request may require the Wi-Fi responding entity to use the preferred Wi-Fi sensing entities listed in the sensing request. The Wi-Fi sensing entities listed in the request may have been selected by the Wi-Fi requesting entity with or without regard to the confidence metrics associated with those entities. This is the case when the sensing-by-proxy request has the Preferred Responder List field set to 1 and the Mandatory Preferred Responder List field set to 1. In certain scenarios, the Wi-Fi requesting entity may select and configure additional Wi-Fi sensing entities beyond those identified in the request. The selection of the additional Wi-Fi sensing entities may be based on a set of confidence metrics obtained by the Wi-Fi responding entity with respect to the added Wi-Fi sensing entities.

If the Wi-Fi requesting entity does not have the confidence metrics associated with the Wi-Fi sensing entities listed in its request, the Wi-Fi responding entity may provide the confidence metrics associated with each such Wi-Fi sensing entity in a sensing report to the Wi-Fi requesting entity. In such instances, the Wi-Fi responding entity does not change the selection of the Wi-Fi sensing entities provided by the Wi-Fi requesting entity. Instead, the Wi-Fi responding entity determines one or more confidence metrics associated with each of the identified Wi-Fi sensing entities and reports those confidence metrics to the Wi-Fi requesting entity. In turn, the Wi-Fi requesting entity may assign a weight to the sensing measurements provided by a given Wi-Fi sensing entity based on the confidence metrics associated with the given Wi-Fi sensing entity. In this manner, the sensing results determined by the Wi-Fi requesting entity are adjusted based on the confidence metrics associated with the Wi-Fi sensing entities used in the sensing session.

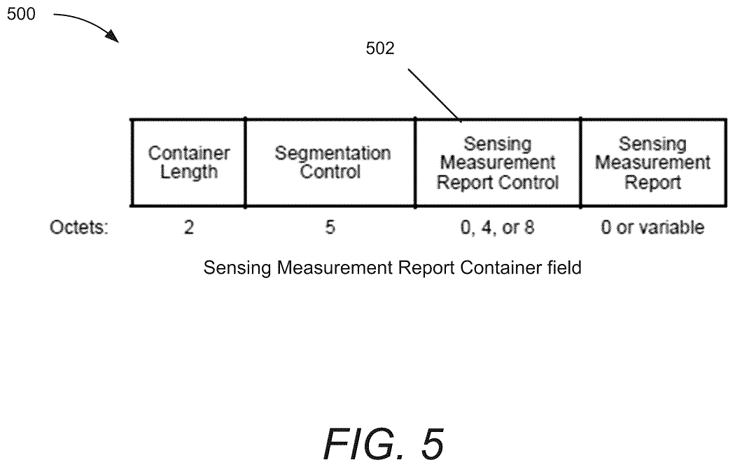

FIG. 5 shows an example Sensing Measurement Report Container field 500, according to aspects of the disclosure. In an aspect, the Sensing Measurement Report Container field 500 is used to carry sensing measurement results obtained from a single sensing measurement exchange. In an aspect, the Sensing Measurement Report Container field 500 can be used to indicate the confidence metrics associated with the Wi-Fi sensing entity whose sensing measurements are being reported. In an aspect, the confidence metrics for the Wi-Fi sensing entity may be determined from the perspective of the Wi-Fi responding entity. The Wi-Fi requesting entity may receive reports for all the STAs in the requested preferred list but can assign a weight to the measurements associated with each Wi-Fi sensing entity based on the confidence metrics associated with each Wi-Fi sensing entity. According to aspects of the disclosure, one or two reserved bits from the 8 bits of the Sensing Measurement Report Control field 502 can be used to indicate the confidence metric of the report from the perspective of the Wi-Fi responding entity.

Certain aspects of the disclosure are directed to the role assigned to a selected Wi-Fi sensing entity for the sensing session. Here, the SR2SR Sounding Request field 312 and the Sensing Preferred Responder Role Bitmap Present field 314 indicate the roles that are to be assigned to the various Wi-Fi entities during the sensing session. However, the assigned roles may be implementation-dependent when the SR2SR Sounding Request field 312 is set to 1, and the Sensing Preferred Responder Role Bitmap Present field 314 is set to 0 (see FIG. 3). In such scenarios, there is no standard specifying which of the Wi-Fi sensing entities is to act as a sensing transmitter or which is to act as a sensing receiver.

According to aspects of the disclosure, the confidence metrics associated with a Wi-Fi sensing entity may also be used as a basis for assigning a role to the Wi-Fi sensing entity. For example, a Wi-Fi sensing entity with a confidence metric indicating that it has more battery power than other Wi-Fi sensing entities can be selected as a sensing transmitter. Additionally, the confidence metrics associated with the channel conditions and proximity of the Wi-Fi sensing entity may also be considered to decide the role the Wi-Fi sensing entity will play in the sensing session.

In certain scenarios, a local/cloud server or central controller may have the complete information or a map of the environment in an enterprise network. In accordance with aspects of the disclosure, the Wi-Fi responding entity (e.g., access point) can provide the sensing reports to the server. In an aspect, the Wi-Fi responding entity may check with the server before responding to a sensing-by-proxy request and configuring the corresponding sensing session. For example, assuming the sensing-by-proxy request has been sent by S1 (see FIG. 4), the local/cloud server can be queried to determine if there is sensing information at the server with respect to S1. If timely sensing information is available for S1 with respect to S2 and S11, the Wi-Fi responding entity need only configure the sensing session for S12 and consolidate the report for S2 and S11 from the local/cloud server. However, depending on the Wi-Fi sensing standards, this consolidation may be limited to instances in which the Preferred Responder List is set to 0 and/or the Mandatory Preferred Responder List field is set to 0 in the sensing-by-proxy request sent by S1.

In certain scenarios, the local/cloud server may have timely reports generated for each STA stored and can send the report to the access point when requested. A confidence metric or weight can be assigned to the report and adjusted based on the age of the sensing data available at the server. In an aspect, the confidence metric associated with the report may be provided in the Sensing Measurement Report Container field 500 (see FIG. 5). However, the access point may proceed with configuring the SBP session without the assistance of the server if the sensing data at the server is older than a time-based threshold or otherwise unavailable.

Certain aspects of the disclosure include selecting Wi-Fi sensing entity candidates based on their diversity. In addition to the confidence metrics, the access point may assess channel correlation or other parameters across the Wi-Fi sensing entities to determine the optimal sensing entities for sensing information extraction.

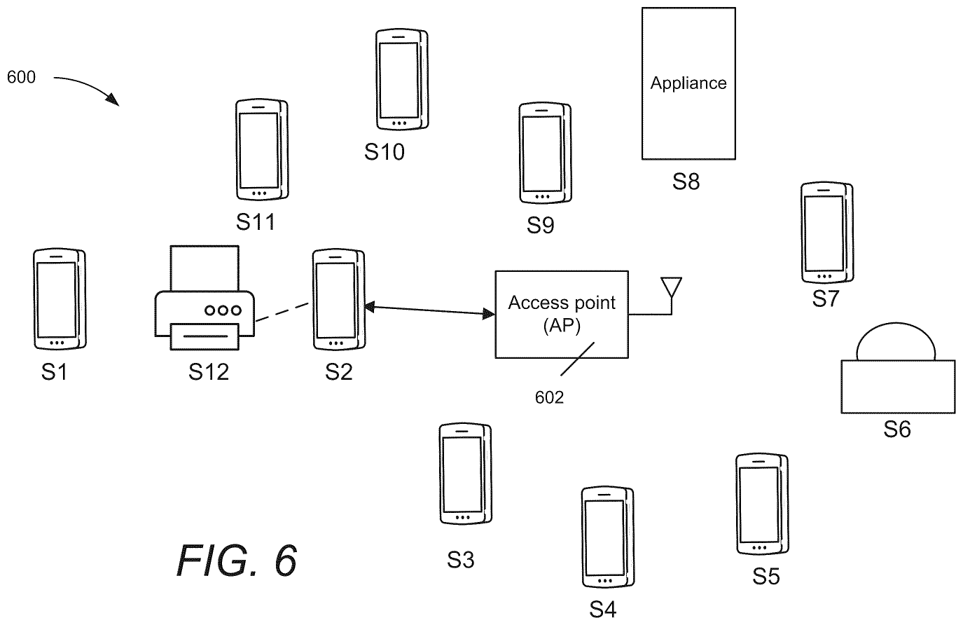

FIG. 6 shows an example sensing environment 600 in which the selection of Wi-Fi sensing entity candidates may be based on diversity, according to aspects of the disclosure. In certain scenarios, the access point 602 may need to configure a Wi-Fi SBP session to perform sensing over a large target area to get more diverse and dynamic assessments of the environment. In such scenarios, the access point may assign higher confidence metrics to Wi-Fi sensing entities that are located at diverse locations or that provide diverse sensing measurements to cover the expansive target area. Channel correlation or other factors may be used to obtain the confidence metrics associated with the Wi-Fi sensing entities needed to assess such diversity. With reference to FIG. 6, Wi-Fi sensing entities S12 and S2 are in close proximity and may experience highly correlated channels. As such, S12 and S2 will likely provide similar environmental sensing information. In such cases, the access point 602 can choose to use only S12 or only S2 if there are power constraints. Alternatively, both S12 and S2 may be employed if there are no power limitations, in which case the sensing information from both may be consolidated, for example, as a single sensing measurement.

As noted herein, the Wi-Fi SBP session may be associated with a particular sensing mode. Besides use cases in which the Wi-Fi requesting entity prefers the Wi-Fi responding entity to perform sensing with Wi-Fi sensing entities close to the Wi-Fi requesting entity, there may be some use cases where sensing is to be done over a large target area. For example, this may be the case when the Wi-Fi SBP session is associated with a “Security Monitoring/Vacation Mode.” In an aspect, a user may communicate with a home-access point with a mobile phone to set such a sensing mode in which whole-house sensing is to be performed for security monitoring while on vacation.

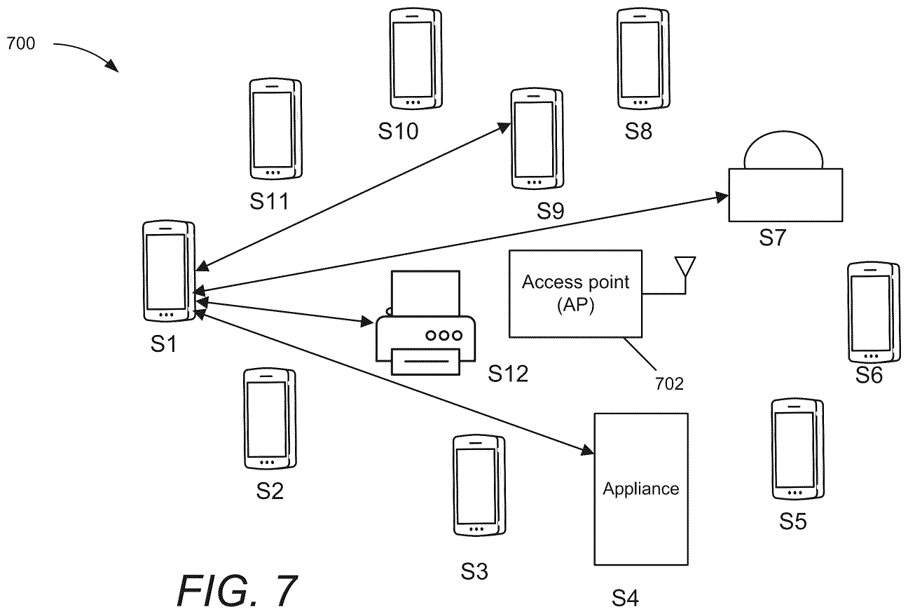

FIG. 7 shows an example sensing environment 700 in which the selection of Wi-Fi sensing entity candidates may be based on a Wi-Fi sensing mode of operation, according to aspects of the disclosure. Here, the access point and 702 may select a set of Wi-Fi sensing entity candidates that are sufficiently separated to cover the area and have diverse locations to cover different directions and distances over the whole-house. In this regard, the access point 702 may consider factors such as channel characteristics, location, and/or other parameters to determine one or more confidence metrics associated with the diversity selection of the Wi-Fi sensing entities that are to participate in the SBP session. In FIG. 7, the access point 702 has selected S4, S12, S7, and S9 for the SBP session requested by S1. The selection of S4, S12, S7, and S9 is based, at least in part, on the confidence metrics associated with the desired diversity for the sensing session. In an aspect, the Wi-Fi responding entity may indicate to a Wi-Fi requesting entity that the requested sensing session will be conducted in accordance with a certain sensing mode of operation. In an aspect, the Wi-Fi responding entity may provide this mode indication using one or more of the eight reserve bits in the SBP Parameters Control field 304 in the sensing response frame sent to the Wi-Fi requesting entity.

Certain aspects of the disclosure are directed to dynamic adjustments to the selection of the Wi-Fi sensing entities participating in an SBP session. Such dynamic adjustments may be made throughout the execution of the sensing session. In an aspect, the dynamic adjustments may include adding Wi-Fi sensing entities to the sensing session, removing Wi-Fi sensing entities from the sensing session, changing the roles of one or more set Wi-Fi sensing entities throughout the sensing session, etc. In an aspect, the Wi-Fi responding entity can make real-time adjustments to Wi-Fi sensing entity selections based on ongoing feedback and performance metrics during a sensing session. Additionally, or in the alternative, the selection of the Wi-Fi sensing entities can be adapted based on contextual factors, such as changes in user requirements or environmental conditions. Wi-Fi responding entities and other STAs in the network can provide feedback on metrics and location parameters, aiding in the continuous tracking of STA selection and optimal resource allocation. As such, a Wi-Fi entity associated with the initial sensing session may be selected as a sensing entity based on its confidence metric but may not be selected as a sensing entity in later sensing sessions based on confidence metrics changes.

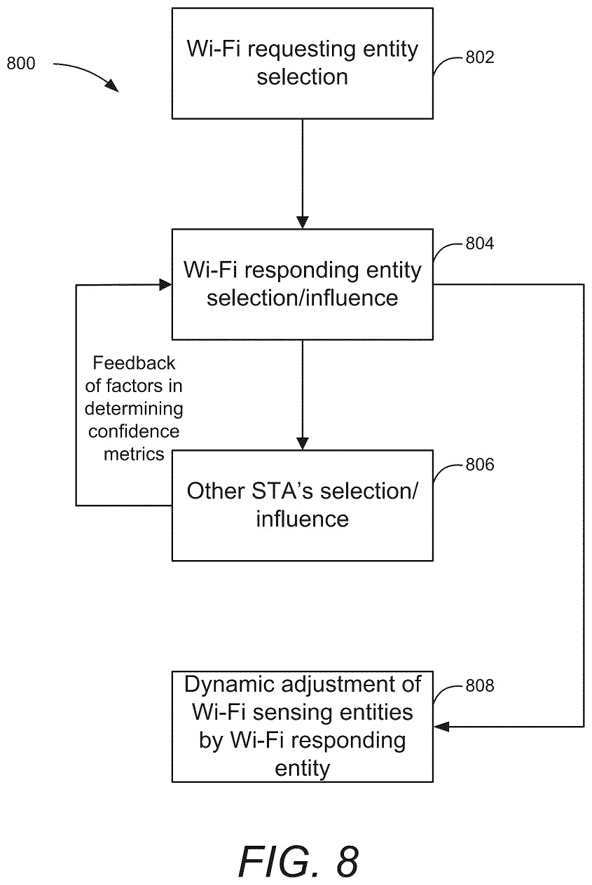

FIG. 8 is a method 800 for dynamically adjusting the selection of the Wi-Fi sensing entities during an SBP positioning session, according to aspects of the disclosure. At operation 802, the Wi-Fi requesting entity selects a set of Wi-Fi sensing entities for use in the sensing session. At operation 804, the Wi-Fi responding entity applies its own set of confidence metrics to influence the selection of the Wi-Fi sensing entities for the positioning session. At operation 806, other STAs (e.g., currently selected Wi-Fi sensing entities, non-selected Wi-Fi sensing entities, or a combination thereof) may influence the selection of the Wi-Fi sensing entities by the Wi-Fi responding entity. In an aspect, the other STAs may experience changes in the factors that are used to determine the confidence metrics (e.g., changes in position, changes in power availability, environmental changes, etc.). In an aspect, the changes to the various factors may be actively fed back to the Wi-Fi responding entity. In turn, the Wi-Fi responding entity uses the feedback for dynamic determination of the confidence factors associated with the Wi-Fi sensing entities and executes any changes to the Wi-Fi sensing entities in response to the dynamically changing confidence metrics.

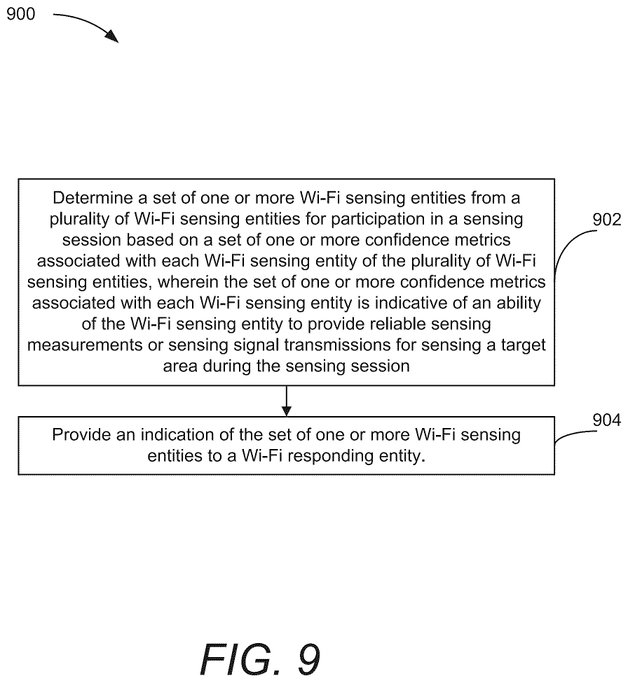

FIG. 9 shows a method 900 performed by a Wi-Fi requesting entity, according to aspects of the disclosure. At operation 902, the Wi-Fi requesting entity determines a set of one or more Wi-Fi sensing entities from a plurality of Wi-Fi sensing entities for participation in a sensing session based on a set of one or more confidence metrics associated with each Wi-Fi sensing entity of the plurality of Wi-Fi sensing entities, wherein the set of one or more confidence metrics associated with each Wi-Fi sensing entity is indicative of an ability of the Wi-Fi sensing entity to provide reliable sensing measurements or sensing signal transmissions for sensing a target area during the sensing session. In an aspect, operation 902 may be performed by the one or more Wi-Fi transceivers 120, the one or more processors 142, memory 140, and/or sensing component 148, any or all of which may be considered means for performing this operation.

At operation 904, the Wi-Fi requesting entity provides an indication of the set of one or more Wi-Fi sensing entities to a Wi-Fi responding entity. In an aspect, operation 904 may be performed by the one or more Wi-Fi transceivers 120, the one or more processors 142, memory 140, and/or sensing component 148, any or all of which may be considered means for performing this operation.

A technical advantage of the method 900 is that it facilitates optimal selection of Wi-Fi sensing entities for an SBP session based on confidence metrics associated with each Wi-Fi sensing entity. Also, confidence metrics can be used for selection of the role a Wi-Fi entity will play during the sensing session.

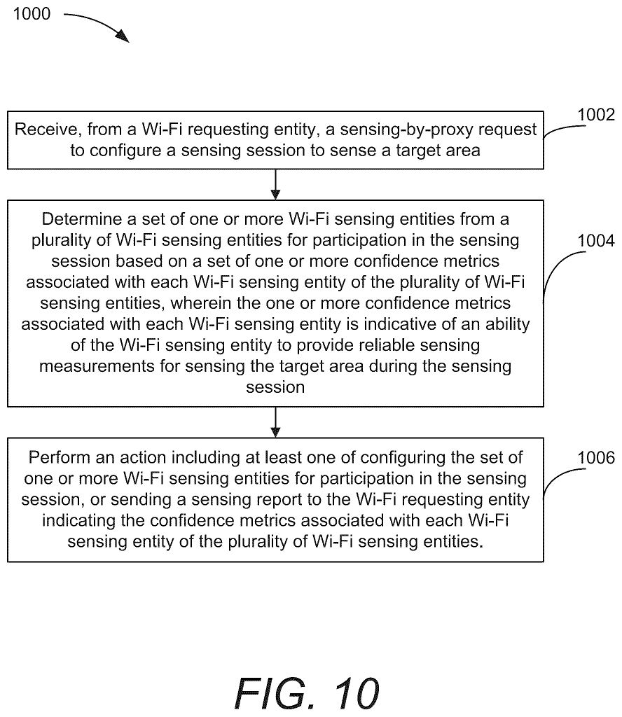

FIG. 10 shows a method 1000 performed by a Wi-Fi responding entity, according to aspects of the disclosure. At operation 1002, the Wi-Fi responding entity receives, from a Wi-Fi requesting entity, a sensing-by-proxy request to configure a sensing session to sense a target area. In an aspect, operation 1002 may be performed by the one or more WWAN transceivers 150, the one or more Wi-Fi transceivers 160, the one or more processors 184, memory 186, and/or sensing component 188, any or all of which may be considered means for performing this operation.

At operation 1004, the Wi-Fi responding entity determines determine a set of one or more Wi-Fi sensing entities from a plurality of Wi-Fi sensing entities for participation in the sensing session based on a set of one or more confidence metrics associated with each Wi-Fi sensing entity of the plurality of Wi-Fi sensing entities, wherein the one or more confidence metrics associated with each Wi-Fi sensing entity is indicative of an ability of the Wi-Fi sensing entity to provide reliable sensing measurements for sensing the target area during the sensing session. In an aspect, operation 1004 may be performed by the one or more WWAN transceivers 150, the one or more Wi-Fi transceivers 160, the one or more processors 184, memory 186, and/or sensing component 188, any or all of which may be considered means for performing this operation.

At operation 1006, the Wi-Fi responding entity performs an action including at least one of configuring the set of one or more Wi-Fi sensing entities for participation in the sensing session, or sending a sensing report to the Wi-Fi requesting entity indicating the confidence metrics associated with each Wi-Fi sensing entity of the plurality of Wi-Fi sensing entities. In an aspect, operation 1006 may be performed by the one or more WWAN transceivers 150, the one or more Wi-Fi transceivers 160, the one or more processors 184, memory 186, and/or sensing component 188, any or all of which may be considered means for performing this operation.

A technical advantage of the method 1000 is that it facilitates optimal selection of Wi-Fi sensing entities for an SBP session based on confidence metrics associated with each Wi-Fi sensing entity.

In the detailed description above, different features are grouped together in the examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:
Clause 1: A method performed by a Wi-Fi requesting entity, comprising: determining a set of one or more Wi-Fi sensing entities from a plurality of Wi-Fi sensing entities for participation in a sensing session based on a set of one or more confidence metrics associated with each Wi-Fi sensing entity of the plurality of Wi-Fi sensing entities, wherein the set of one or more confidence metrics associated with each Wi-Fi sensing entity is indicative of an ability of the Wi-Fi sensing entity to provide reliable sensing measurements or sensing signal transmissions for sensing a target area during the sensing session; and providing an indication of the set of one or more Wi-Fi sensing entities to a Wi-Fi responding entity.
Clause 2: The method of clause 1, wherein the providing the indication of the set of one or more Wi-Fi sensing entities to a Wi-Fi responding entity includes sending a sensing-by-proxy request including the indication of the set of one or more Wi-Fi sensing entities to the Wi-Fi responding entity.
Clause 3: The method of any of clauses 1 to 2, wherein the providing the indication of the set of one or more Wi-Fi sensing entities to the Wi-Fi responding entity includes providing a list of Wi-Fi sensing entities based on the set of one or more confidence metrics associated with each Wi-Fi sensing entity of the set of one or more Wi-Fi sensing entities to the Wi-Fi responding entity.
Clause 4: The method of any of clauses 1 to 3, wherein the indication of the set of one or more Wi-Fi sensing entities includes an indication of a preferred set of one or more Wi-Fi sensing entity candidates available for selection by the Wi-Fi responding entity.
Clause 5: The method of any of clauses 1 to 4, wherein the indication of the set of one or more Wi-Fi sensing entities includes an indication of a set of one or more mandatory Wi-Fi sensing entities for configuration by the Wi-Fi responding entity for the sensing session.
Clause 6: The method of any of clauses 1 to 5, wherein the indication of the set of one or more Wi-Fi sensing entities is indicated by at least a portion of a standardized Medium Access Control Layer Management Entity (MLME) sensing-by-proxy primitive.

Clause 7: The method of any of clauses 1 to 6, wherein the set of one or more confidence metrics associated with each Wi-Fi sensing entity is based on: a mobility state of the Wi-Fi sensing entity, an absolute location of the Wi-Fi sensing entity, an estimated location of the Wi-Fi sensing entity, channel conditions between the Wi-Fi requesting entity and the Wi-Fi sensing entity, bandwidth capability of the Wi-Fi sensing entity, transmission power capability of the Wi-Fi sensing entity, processing power capability of the Wi-Fi sensing entity, an error estimate associated with the Wi-Fi sensing entity, Radio Access Technology (RAT) Availability of the Wi-Fi sensing entity, or any combination thereof.
Clause 8: The method of any of clauses 1 to 7, wherein the set of one or more confidence metrics associated with each Wi-Fi sensing entity is based on: received signal strength indicator (RSSI) measurements of signals received from the Wi-Fi sensing entity at the Wi-Fi requesting entity, round-trip time (RTT) measurements of signals transmitted between the Wi-Fi sensing entity and the Wi-Fi requesting entity, angle-of-arrival (AoA) measurements of signals transmitted between the Wi-Fi sensing entity and the Wi-Fi requesting entity, or any combination thereof.
Clause 9: A method performed by a Wi-Fi responding entity, comprising: receiving, from a Wi-Fi requesting entity, a sensing-by-proxy request to configure a sensing session to sense a target area; determining a set of one or more Wi-Fi sensing entities from a plurality of Wi-Fi sensing entities for participation in the sensing session based on a set of one or more confidence metrics associated with each Wi-Fi sensing entity of the plurality of Wi-Fi sensing entities, wherein the one or more confidence metrics associated with each Wi-Fi sensing entity is indicative of an ability of the Wi-Fi sensing entity to provide reliable sensing measurements for sensing the target area during the sensing session; and performing an action including at least one of configuring the set of one or more Wi-Fi sensing entities for participation in the sensing session, or sending a sensing report to the Wi-Fi requesting entity indicating the confidence metrics associated with each Wi-Fi sensing entity of the plurality of Wi-Fi sensing entities.
Clause 10: The method of clause 9, wherein the sensing-by-proxy request indicates a preferred set of one or more Wi-Fi sensing entity candidates for use during the sensing session.
Clause 11: The method of any of clauses 9 to 10, wherein the preferred set of one or more Wi-Fi sensing entities are determined by the Wi-Fi requesting entity from nearby sensing entities based on confidence metrics associated with the nearby sensing entities.
Clause 12: The method of any of clauses 9 to 11, wherein determining the set of one or more Wi-Fi sensing entities from the plurality of Wi-Fi sensing entities, comprises: selecting the set of one or more Wi-Fi sensing entities from the preferred set of one or more Wi-Fi sensing entity candidates based on the set of one or more confidence metrics associated with each Wi-Fi sensing entity of the preferred set of one or more Wi-Fi sensing entity candidates.
Clause 13: The method of any of clauses 9 to 12, wherein determining the set of one or more Wi-Fi sensing entities from the plurality of Wi-Fi sensing entities further comprises: selecting a Wi-Fi sensing entity from the plurality of Wi-Fi sensing entities that is not included in the preferred set of one or more Wi-Fi sensing entity candidates based on an indication in a reserved field of the sensing-by-proxy request.
Clause 14: The method of any of clauses 9 to 13, wherein the preferred set of one or more Wi-Fi sensing entity candidates is determined by the Wi-Fi requesting entity based on confidence metrics associated with the one or more Wi-Fi sensing entities; and determining the set of one or more Wi-Fi sensing entities from the plurality of Wi-Fi sensing entities comprises: selecting the set of one or more Wi-Fi sensing entities from the preferred set of one or more Wi-Fi sensing entity candidates based on the set of one or more confidence metrics associated with each Wi-Fi sensing entity of the preferred set of one or more Wi-Fi sensing entity candidates.
Clause 15: The method of any of clauses 9 to 14, wherein the sensing-by-proxy request indicates the preferred set of one or more Wi-Fi sensing entity candidates and a mandatory set of one or more Wi-Fi sensing entity candidates to be used during the sensing session.
Clause 16: The method of any of clauses 9 to 15, wherein determining the set of one or more Wi-Fi sensing entities from the plurality of Wi-Fi sensing entities comprises: determining the set of one or more Wi-Fi sensing entities based on the preferred set of one or more Wi-Fi sensing entity candidates and a mandatory preferred set of one or more Wi-Fi sensing entity candidates; and the method further comprises: sending a sensing report to the Wi-Fi requesting entity indicating the confidence metrics associated with each of the set of one or more Wi-Fi sensing entities for use by the Wi-Fi requesting entity in configuring a weight for sensing measurements obtained by each Wi-Fi sensing entity of the set of one or more Wi-Fi sensing entities.
Clause 17: The method of any of clauses 9 to 16, further comprising: assigning a role to a given Wi-Fi sensing entity of the preferred set of one or more Wi-Fi sensing entity candidates as a sensing transmitter or a sensing receiver based on the one or more confidence metrics associated with the given Wi-Fi sensing entity.
Clause 18: The method of any of clauses 9 to 17, wherein the role is assigned to the given Wi-Fi sensing entity of the preferred set of one or more Wi-Fi sensing entity candidates based on an absence of a specific role for the given Wi-Fi sensing being designated in the sensing-by-proxy request.
Clause 19: The method of any of clauses 9 to 18, further comprising: periodically updating at least one characteristic used to determine at least one confidence metric of at least one Wi-Fi sensing entity of the plurality of Wi-Fi sensing entities.
Clause 20: The method of any of clauses 9 to 19, further comprising: sending, to a network server, sensing information associated with one or more Wi-Fi sensing entities of the plurality of Wi-Fi sensing entities.
Clause 21: The method of any of clauses 9 to 20, further comprising: obtaining, from a network server, sensing information associated with the one or more Wi-Fi sensing entities; and the configuring of the set of one or more Wi-Fi sensing entities based, at least in part, on the sensing information obtained from the network server.
Clause 22: The method of any of clauses 9 to 21, wherein the set of one or more confidence metrics associated with each Wi-Fi sensing entity is based on: a mobility state of the Wi-Fi sensing entity, an absolute location of the Wi-Fi sensing entity, an estimated location of the Wi-Fi sensing entity, channel conditions associated with the Wi-Fi sensing entity, bandwidth capability of the Wi-Fi sensing entity, transmission power capability of the Wi-Fi sensing entity, processing power capability of the Wi-Fi sensing entity, an error estimate associated with the Wi-Fi sensing entity, Radio Access Technology (RAT) Availability of the Wi-Fi sensing entity, or any combination thereof.
Clause 23: The method of any of clauses 9 to 22, wherein the set of one or more confidence metrics associated with each Wi-Fi sensing entity is based on: received signal strength indicator (RSSI) measurements of signals received from the Wi-Fi sensing entity at the Wi-Fi responding entity; round-trip time (RTT) measurements of signals transmitted between the Wi-Fi sensing entity and the Wi-Fi responding entity; angle-of-arrival (AoA) measurements of signals transmitted between the Wi-Fi sensing entity and the Wi-Fi responding entity; or any combination thereof.
Clause 24: The method of any of clauses 9 to 23, wherein determining the set of one or more Wi-Fi sensing entities from the plurality of Wi-Fi sensing entities for participation in the sensing session is further based on diversity of the plurality of Wi-Fi sensing entities.
Clause 25: The method of any of clauses 9 to 24, further comprising: sending a sensing mode indicator to the Wi-Fi requesting entity, wherein the sensing mode indicator corresponds to location diversity criteria used by the Wi-Fi responding entity to select the set of one or more Wi-Fi sending entities.
Clause 26: The method of any of clauses 9 to 25, further comprising: updating the set of one or more confidence metrics associated with one or more Wi-Fi sensing entities of the plurality of Wi-Fi sensing entities during the sensing session; and dynamically adjusting the Wi-Fi sensing entities participating in the sensing session based on the updated set of one or more confidence metrics.
Clause 27: A Wi-Fi requesting entity, comprising: one or more memories; one or more transceivers; and one or more processors communicatively coupled to the one or more memories and the one or more transceivers, the one or more processors, either alone or in combination, configured to: determine a set of one or more Wi-Fi sensing entities from a plurality of Wi-Fi sensing entities for participation in a sensing session based on a set of one or more confidence metrics associated with each Wi-Fi sensing entity of the plurality of Wi-Fi sensing entities, wherein the set of one or more confidence metrics associated with each Wi-Fi sensing entity is indicative of an ability of the Wi-Fi sensing entity to provide reliable sensing measurements or sensing signal transmissions for sensing a target area during the sensing session; and provide an indication of the set of one or more Wi-Fi sensing entities to a Wi-Fi responding entity.
Clause 28: The Wi-Fi requesting entity of clause 27, wherein the providing the indication of the set of one or more Wi-Fi sensing entities to the Wi-Fi responding entity includes sending a sensing-by-proxy request including the indication of the set of one or more Wi-Fi sensing entities to the Wi-Fi responding entity.
Clause 29: The Wi-Fi requesting entity of any of clauses 27 to 28, wherein the providing the indication of the set of one or more Wi-Fi sensing entities to the Wi-Fi responding entity includes providing a list of Wi-Fi sensing entities based on the set of one or more confidence metrics associated with each Wi-Fi sensing entity of the set of one or more Wi-Fi sensing entities to the Wi-Fi responding entity.
Clause 30: The Wi-Fi requesting entity of any of clauses 27 to 29, wherein the indication of the set of one or more Wi-Fi sensing entities includes an indication of a preferred set of one or more Wi-Fi sensing entity candidates available for selection by the Wi-Fi responding entity.
Clause 31: The Wi-Fi requesting entity of any of clauses 27 to 30, wherein the indication of the set of one or more Wi-Fi sensing entities includes an indication of a set of one or more mandatory Wi-Fi sensing entities for configuration by the Wi-Fi responding entity for the sensing session.
Clause 32: The Wi-Fi requesting entity of any of clauses 27 to 31, wherein the indication of the set of one or more Wi-Fi sensing entities is indicated by at least a portion of a standardized Medium Access Control Layer Management Entity (MLME) sensing-by-proxy primitive.
Clause 33: The Wi-Fi requesting entity of any of clauses 27 to 32, wherein the set of one or more confidence metrics associated with each Wi-Fi sensing entity is based on: a mobility state of the Wi-Fi sensing entity; an absolute location of the Wi-Fi sensing entity; an estimated location of the Wi-Fi sensing entity; channel conditions between the Wi-Fi requesting entity and the Wi-Fi sensing entity; bandwidth capability of the Wi-Fi sensing entity; transmission power capability of the Wi-Fi sensing entity; processing power capability of the Wi-Fi sensing entity; an error estimate associated with the Wi-Fi sensing entity; Radio Access Technology (RAT) Availability of the Wi-Fi sensing entity, or; and any combination thereof.
Clause 34: The Wi-Fi requesting entity of any of clauses 27 to 33, wherein the set of one or more confidence metrics associated with each Wi-Fi sensing entity is based on: received signal strength indicator (RSSI) measurements of signals received from the Wi-Fi sensing entity at the Wi-Fi requesting entity; round-trip time (RTT) measurements of signals transmitted between the Wi-Fi sensing entity and the Wi-Fi requesting entity; angle-of-arrival (AoA) measurements of signals transmitted between the Wi-Fi sensing entity and the Wi-Fi requesting entity, or; and any combination thereof.
Clause 35: A Wi-Fi requesting entity, comprising: means for determining a set of one or more Wi-Fi sensing entities from a plurality of Wi-Fi sensing entities for participation in a sensing session based on a set of one or more confidence metrics associated with each Wi-Fi sensing entity of the plurality of Wi-Fi sensing entities, wherein the set of one or more confidence metrics associated with each Wi-Fi sensing entity is indicative of an ability of the Wi-Fi sensing entity to provide reliable sensing measurements or sensing signal transmissions for sensing a target area during the sensing session; and means for providing an indication of the set of one or more Wi-Fi sensing entities to a Wi-Fi responding entity.
Clause 36: The Wi-Fi requesting entity of clause 35, wherein the means for providing the indication of the set of one or more Wi-Fi sensing entities to a Wi-Fi responding entity includes means for sending a sensing-by-proxy request including the indication of the set of one or more Wi-Fi sensing entities to the Wi-Fi responding entity.
Clause 37: The Wi-Fi requesting entity of any of clauses 35 to 36, wherein the means for providing the indication of the set of one or more Wi-Fi sensing entities to the Wi-Fi responding entity includes means for providing a list of Wi-Fi sensing entities based on the set of one or more confidence metrics associated with each Wi-Fi sensing entity of the set of one or more Wi-Fi sensing entities to the Wi-Fi responding entity.
Clause 38: The Wi-Fi requesting entity of any of clauses 35 to 37, wherein the indication of the set of one or more Wi-Fi sensing entities includes an indication of a preferred set of one or more Wi-Fi sensing entity candidates available for selection by the Wi-Fi responding entity.
Clause 39: The Wi-Fi requesting entity of any of clauses 35 to 38, wherein the indication of the set of one or more Wi-Fi sensing entities includes an indication of a set of one or more mandatory Wi-Fi sensing entities for configuration by the Wi-Fi responding entity for the sensing session.
Clause 40: The Wi-Fi requesting entity of any of clauses 35 to 39, wherein the indication of the set of one or more Wi-Fi sensing entities is indicated by at least a portion of a standardized Medium Access Control Layer Management Entity (MLME) sensing-by-proxy primitive.
Clause 41: The Wi-Fi requesting entity of any of clauses 35 to 40, wherein the set of one or more confidence metrics associated with each Wi-Fi sensing entity is based on: a mobility state of the Wi-Fi sensing entity an absolute location of the Wi-Fi sensing entity an estimated location of the Wi-Fi sensing entity channel conditions between the Wi-Fi requesting entity and the Wi-Fi sensing entity bandwidth capability of the Wi-Fi sensing entity transmission power capability of the Wi-Fi sensing entity processing power capability of the Wi-Fi sensing entity an error estimate associated with the Wi-Fi sensing entity Radio Access Technology (RAT) Availability of the Wi-Fi sensing entity, or any combination thereof.
Clause 42: The Wi-Fi requesting entity of any of clauses 35 to 41, wherein the set of one or more confidence metrics associated with each Wi-Fi sensing entity is based on: received signal strength indicator (RSSI) measurements of signals received from the Wi-Fi sensing entity at the Wi-Fi requesting entity round-trip time (RTT) measurements of signals transmitted between the Wi-Fi sensing entity and the Wi-Fi requesting entity angle-of-arrival (AoA) measurements of signals transmitted between the Wi-Fi sensing entity and the Wi-Fi requesting entity, or any combination thereof.
Clause 43: A non-transitory computer-readable medium storing computer-executable instructions that, when executed by a Wi-Fi requesting entity, cause the Wi-Fi requesting entity to: determine a set of one or more Wi-Fi sensing entities from a plurality of Wi-Fi sensing entities for participation in a sensing session based on a set of one or more confidence metrics associated with each Wi-Fi sensing entity of the plurality of Wi-Fi sensing entities, wherein the set of one or more confidence metrics associated with each Wi-Fi sensing entity is indicative of an ability of the Wi-Fi sensing entity to provide reliable sensing measurements or sensing signal transmissions for sensing a target area during the sensing session; and provide an indication of the set of one or more Wi-Fi sensing entities to a Wi-Fi responding entity.
Clause 44: The non-transitory computer-readable medium of clause 43, wherein the providing the indication of the set of one or more Wi-Fi sensing entities to a Wi-Fi responding entity includes sending a sensing-by-proxy request including the indication of the set of one or more Wi-Fi sensing entities to the Wi-Fi responding entity.
Clause 45: The non-transitory computer-readable medium of any of clauses 43 to 44, wherein the providing the indication of the set of one or more Wi-Fi sensing entities to the Wi-Fi responding entity includes providing a list of Wi-Fi sensing entities based on the set of one or more confidence metrics associated with each Wi-Fi sensing entity of the set of one or more Wi-Fi sensing entities to the Wi-Fi responding entity.
Clause 46: The non-transitory computer-readable medium of any of clauses 43 to 45, wherein the indication of the set of one or more Wi-Fi sensing entities includes an indication of a preferred set of one or more Wi-Fi sensing entity candidates available for selection by the Wi-Fi responding entity.
Clause 47: The non-transitory computer-readable medium of any of clauses 43 to 46, wherein the indication of the set of one or more Wi-Fi sensing entities includes an indication of a set of one or more mandatory Wi-Fi sensing entities for configuration by the Wi-Fi responding entity for the sensing session.
Clause 48: The non-transitory computer-readable medium of any of clauses 43 to 47, wherein the indication of the set of one or more Wi-Fi sensing entities is indicated by at least a portion of a standardized Medium Access Control Layer Management Entity (MLME) sensing-by-proxy primitive.
Clause 49: The non-transitory computer-readable medium of any of clauses 43 to 48, wherein the set of one or more confidence metrics associated with each Wi-Fi sensing entity is based on: a mobility state of the Wi-Fi sensing entity; an absolute location of the Wi-Fi sensing entity; an estimated location of the Wi-Fi sensing entity; channel conditions between the Wi-Fi requesting entity and the Wi-Fi sensing entity; bandwidth capability of the Wi-Fi sensing entity; transmission power capability of the Wi-Fi sensing entity; processing power capability of the Wi-Fi sensing entity; an error estimate associated with the Wi-Fi sensing entity; Radio Access Technology (RAT) Availability of the Wi-Fi sensing entity, or; and any combination thereof.
Clause 50: The non-transitory computer-readable medium of any of clauses 43 to 49, wherein the set of one or more confidence metrics associated with each Wi-Fi sensing entity is based on: received signal strength indicator (RSSI) measurements of signals received from the Wi-Fi sensing entity at the Wi-Fi requesting entity; round-trip time (RTT) measurements of signals transmitted between the Wi-Fi sensing entity and the Wi-Fi requesting entity; angle-of-arrival (AoA) measurements of signals transmitted between the Wi-Fi sensing entity and the Wi-Fi requesting entity, or; and any combination thereof.
Clause 51: A Wi-Fi responding entity, comprising: one or more memories; one or more transceivers; and one or more processors communicatively coupled to the one or more memories and the one or more transceivers, the one or more processors, either alone or in combination, configured to: receive, from a Wi-Fi requesting entity, a sensing-by-proxy request to configure a sensing session to sense a target area; determine a set of one or more Wi-Fi sensing entities from a plurality of Wi-Fi sensing entities for participation in the sensing session based on a set of one or more confidence metrics associated with each Wi-Fi sensing entity of the plurality of Wi-Fi sensing entities, wherein the one or more confidence metrics associated with each Wi-Fi sensing entity is indicative of an ability of the Wi-Fi sensing entity to provide reliable sensing measurements for sensing the target area during the sensing session; and perform an action including at least one of configure the set of one or more Wi-Fi sensing entities for participation in the sensing session, or send a sensing report to the Wi-Fi requesting entity indicating the confidence metrics associated with each Wi-Fi sensing entity of the plurality of Wi-Fi sensing entities.
Clause 52: The Wi-Fi responding entity of clause 51, wherein the sensing-by-proxy request indicates a preferred set of one or more Wi-Fi sensing entity candidates for use during the sensing session.
Clause 53: The Wi-Fi responding entity of any of clauses 51 to 52, wherein the preferred set of one or more Wi-Fi sensing entities are determined by the Wi-Fi requesting entity from nearby sensing entities based on confidence metrics associated with the nearby sensing entities.
Clause 54: The Wi-Fi responding entity of any of clauses 51 to 53, wherein the one or more processors, when determining the set of one or more Wi-Fi sensing entities from the plurality of Wi-Fi sensing entities, are configured to: select the set of one or more Wi-Fi sensing entities from the preferred set of one or more Wi-Fi sensing entity candidates based on the set of one or more confidence metrics associated with each Wi-Fi sensing entity of the preferred set of one or more Wi-Fi sensing entity candidates.
Clause 55: The Wi-Fi responding entity of any of clauses 51 to 54, wherein the one or more processors, when determining the set of one or more Wi-Fi sensing entities from the plurality of Wi-Fi sensing entities, are configured to: select a Wi-Fi sensing entity from the plurality of Wi-Fi sensing entities that is not included in the preferred set of one or more Wi-Fi sensing entity candidates based on an indication in a reserved field of the sensing-by-proxy request.
Clause 56: The Wi-Fi responding entity of any of clauses 51 to 55, wherein the preferred set of one or more Wi-Fi sensing entity candidates is determined by the Wi-Fi requesting entity based on confidence metrics associated with the one or more Wi-Fi sensing entities; and determining the set of one or more Wi-Fi sensing entities from the plurality of Wi-Fi sensing entities comprises: selecting the set of one or more Wi-Fi sensing entities from the preferred set of one or more Wi-Fi sensing entity candidates based on the set of one or more confidence metrics associated with each Wi-Fi sensing entity of the preferred set of one or more Wi-Fi sensing entity candidates.
Clause 57: The Wi-Fi responding entity of any of clauses 51 to 56, wherein the sensing-by-proxy request indicates the preferred set of one or more Wi-Fi sensing entity candidates and a mandatory set of one or more Wi-Fi sensing entity candidates to be used during the sensing session.
Clause 58: The Wi-Fi responding entity of any of clauses 51 to 57, wherein the one or more processors, when determining the set of one or more Wi-Fi sensing entities from the plurality of Wi-Fi sensing entities, are configured to: determine the set of one or more Wi-Fi sensing entities based on the preferred set of one or more Wi-Fi sensing entity candidates and a mandatory preferred set of one or more Wi-Fi sensing entity candidates; and the one or more processors either alone in combination are further configured to: send a sensing report to the Wi-Fi requesting entity indicating the confidence metrics associated with each of the set of one or more Wi-Fi sensing entities for use by the Wi-Fi requesting entity in configuring a weight for sensing measurements obtained by each Wi-Fi sensing entity of the set of one or more Wi-Fi sensing entities.
Clause 59: The Wi-Fi responding entity of any of clauses 51 to 58, wherein the one or more processors, either alone or in combination, are further configured to: assign a role to a given Wi-Fi sensing entity of the preferred set of one or more Wi-Fi sensing entity candidates as a sensing transmitter or a sensing receiver based on the one or more confidence metrics associated with the given Wi-Fi sensing entity.
Clause 60: The Wi-Fi responding entity of any of clauses 51 to 59, wherein the role is assigned to the given Wi-Fi sensing entity of the preferred set of one or more Wi-Fi sensing entity candidates based on an absence of a specific role for the given Wi-Fi sensing being designated in the sensing-by-proxy request.
Clause 61: The Wi-Fi responding entity of any of clauses 51 to 60, wherein the one or more processors, either alone or in combination, are further configured to: periodically update at least one characteristic used to determine at least one confidence metric of at least one Wi-Fi sensing entity of the plurality of Wi-Fi sensing entities.
Clause 62: The Wi-Fi responding entity of any of clauses 51 to 61, wherein the one or more processors, either alone or in combination, are further configured to: send, to a network server, sensing information associated with one or more Wi-Fi sensing entities of the plurality of Wi-Fi sensing entities.
Clause 63: The Wi-Fi responding entity of any of clauses 51 to 62, wherein the one or more processors, either alone or in combination, are further configured to: obtain, from a network server, sensing information associated with the one or more Wi-Fi sensing entities; and configuring of the set of one or more Wi-Fi sense entities based, at least in part, on the sensing information obtained from the network server.
Clause 64: The Wi-Fi responding entity of any of clauses 51 to 63, wherein the set of one or more confidence metrics associated with each Wi-Fi sensing entity is based on: a mobility state of the Wi-Fi sensing entity; an absolute location of the Wi-Fi sensing entity; an estimated location of the Wi-Fi sensing entity; channel conditions associated with the Wi-Fi sensing entity; bandwidth capability of the Wi-Fi sensing entity; transmission power capability of the Wi-Fi sensing entity; processing power capability of the Wi-Fi sensing entity; an error estimate associated with the Wi-Fi sensing entity; Radio Access Technology (RAT) Availability of the Wi-Fi sensing entity, or; and any combination thereof.
Clause 65: The Wi-Fi responding entity of any of clauses 51 to 64, wherein the set of one or more confidence metrics associated with each Wi-Fi sensing entity is based on: received signal strength indicator (RSSI) measurements of signals received from the Wi-Fi sensing entity at the Wi-Fi responding entity; round-trip time (RTT) measurements of signals transmitted between the Wi-Fi sensing entity and the Wi-Fi responding entity; angle-of-arrival (AoA) measurements of signals transmitted between the Wi-Fi sensing entity and the Wi-Fi responding entity; or any combination thereof.
Clause 66: The Wi-Fi responding entity of any of clauses 51 to 65, wherein determining the set of one or more Wi-Fi sensing entities from the plurality of Wi-Fi sensing entities for participation in the sensing session is further based on diversity of the plurality of Wi-Fi sensing entities.
Clause 67: The Wi-Fi responding entity of any of clauses 51 to 66, wherein the one or more processors, either alone or in combination, are further configured to: send a sensing mode indicator to the Wi-Fi requesting entity, wherein the sensing mode indicator corresponds to location diversity criteria used by the Wi-Fi responding entity to select the set of one or more Wi-Fi sending entities.
Clause 68: The Wi-Fi responding entity of any of clauses 51 to 67, wherein the one or more processors, either alone or in combination, are further configured to: update the set of one or more confidence metrics associated with one or more Wi-Fi sensing entities of the plurality of Wi-Fi sensing entities during the sensing session; and dynamically adjust the Wi-Fi sensing entities participating in the sensing session based on the updated set of one or more confidence metrics.
Clause 69: A Wi-Fi responding entity, comprising: means for receiving, from a Wi-Fi requesting entity, a sensing-by-proxy request to configure a sensing session to sense a target area; means for determining a set of one or more Wi-Fi sensing entities from a plurality of Wi-Fi sensing entities for participation in the sensing session based on a set of one or more confidence metrics associated with each Wi-Fi sensing entity of the plurality of Wi-Fi sensing entities, wherein the one or more confidence metrics associated with each Wi-Fi sensing entity is indicative of an ability of the Wi-Fi sensing entity to provide reliable sensing measurements for sensing the target area during the sensing session; and means for performing an action including at least one of; means for configuring the set of one or more Wi-Fi sensing entities for participation in the sensing session, or; and means for sending a sensing report to the Wi-Fi requesting entity indicating the confidence metrics associated with each Wi-Fi sensing entity of the plurality of Wi-Fi sensing entities.
Clause 70: The Wi-Fi responding entity of clause 69, wherein the sensing-by-proxy request indicates a preferred set of one or more Wi-Fi sensing entity candidates for use during the sensing session.
Clause 71: The Wi-Fi responding entity of any of clauses 69 to 70, wherein the preferred set of one or more Wi-Fi sensing entities are determined by the Wi-Fi requesting entity from nearby sensing entities based on confidence metrics associated with the nearby sensing entities.
Clause 72: The Wi-Fi responding entity of any of clauses 69 to 71, wherein determining the means for determining set of one or more Wi-Fi sensing entities from the plurality of Wi-Fi sensing entities, comprises: means for selecting the set of one or more Wi-Fi sensing entities from the preferred set of one or more Wi-Fi sensing entity candidates based on the set of one or more confidence metrics associated with each Wi-Fi sensing entity of the preferred set of one or more Wi-Fi sensing entity candidates.
Clause 73: The Wi-Fi responding entity of any of clauses 69 to 72, wherein means for determining the set of one or more Wi-Fi sensing entities from the plurality of Wi-Fi sensing entities further comprises: means for selecting a Wi-Fi sensing entity from the plurality of Wi-Fi sensing entities that is not included in the preferred set of one or more Wi-Fi sensing entity candidates based on an indication in a reserved field of the sensing-by-proxy request.
Clause 74: The Wi-Fi responding entity of any of clauses 69 to 73, wherein the preferred set of one or more Wi-Fi sensing entity candidates is determined by the Wi-Fi requesting entity based on confidence metrics associated with the one or more Wi-Fi sensing entities; and the means for determining the set of one or more Wi-Fi sensing entities from the plurality of Wi-Fi sensing entities comprises: means for selecting the set of one or more Wi-Fi sensing entities from the preferred set of one or more Wi-Fi sensing entity candidates based on the set of one or more confidence metrics associated with each Wi-Fi sensing entity of the preferred set of one or more Wi-Fi sensing entity candidates.
Clause 75: The Wi-Fi responding entity of any of clauses 69 to 74, wherein the sensing-by-proxy request indicates the preferred set of one or more Wi-Fi sensing entity candidates and a mandatory set of one or more Wi-Fi sensing entity candidates to be used during the sensing session.
Clause 76: The Wi-Fi responding entity of any of clauses 69 to 75, wherein the means for determining the set of one or more Wi-Fi sensing entities from the plurality of Wi-Fi sensing entities comprises: means for determining the set of one or more Wi-Fi sensing entities based on the preferred set of one or more Wi-Fi sensing entity candidates and a mandatory preferred set of one or more Wi-Fi sensing entity candidates; and the Wi-Fi responding entity further comprises: means for sending a sensing report to the Wi-Fi requesting entity indicating the confidence metrics associated with each of the set of one or more Wi-Fi sensing entities for use by the Wi-Fi requesting entity in configuring a weight for sensing measurements obtained by each Wi-Fi sensing entity of the set of one or more Wi-Fi sensing entities.
Clause 77: The Wi-Fi responding entity of any of clauses 69 to 76, further comprising: means for assigning a role to a given Wi-Fi sensing entity of the preferred set of one or more Wi-Fi sensing entity candidates as a sensing transmitter or a sensing receiver based on the one or more confidence metrics associated with the given Wi-Fi sensing entity.
Clause 78: The Wi-Fi responding entity of any of clauses 69 to 77, wherein the role is assigned to the given Wi-Fi sensing entity of the preferred set of one or more Wi-Fi sensing entity candidates based on an absence of a specific role for the given Wi-Fi sensing being designated in the sensing-by-proxy request.
Clause 79: The Wi-Fi responding entity of any of clauses 69 to 78, further comprising: means for periodically updating at least one characteristic used to determine at least one confidence metric of at least one Wi-Fi sensing entity of the plurality of Wi-Fi sensing entities.
Clause 80: The Wi-Fi responding entity of any of clauses 69 to 79, further comprising: means for sending, to a network server, sensing information associated with one or more Wi-Fi sensing entities of the plurality of Wi-Fi sensing entities.
Clause 81: The Wi-Fi responding entity of any of clauses 69 to 80, further comprising: means for obtaining, from a network server, sensing information associated with the one or more Wi-Fi sensing entities; and the configuring of the set of one or more Wi-Fi sensing entities based, at least in part, on the sensing information obtained from the network server.
Clause 82: The Wi-Fi responding entity of any of clauses 69 to 81, wherein the set of one or more confidence metrics associated with each Wi-Fi sensing entity is based on: a mobility state of the Wi-Fi sensing entity an absolute location of the Wi-Fi sensing entity an estimated location of the Wi-Fi sensing entity channel conditions associated with the Wi-Fi sensing entity bandwidth capability of the Wi-Fi sensing entity transmission power capability of the Wi-Fi sensing entity processing power capability of the Wi-Fi sensing entity an error estimate associated with the Wi-Fi sensing entity Radio Access Technology (RAT) Availability of the Wi-Fi sensing entity, or any combination thereof.
Clause 83: The Wi-Fi responding entity of any of clauses 69 to 82, wherein the set of one or more confidence metrics associated with each Wi-Fi sensing entity is based on: received signal strength indicator (RSSI) measurements of signals received from the Wi-Fi sensing entity at the Wi-Fi responding entity round-trip time (RTT) measurements of signals transmitted between the Wi-Fi sensing entity and the Wi-Fi responding entity angle-of-arrival (AoA) measurements of signals transmitted between the Wi-Fi sensing entity and the Wi-Fi responding entity angle-of-arrival (AoA) measurements of signals transmitted between the Wi-Fi sensing entity and the Wi-Fi responding entity any combination thereof.
Clause 84: The Wi-Fi responding entity of any of clauses 69 to 83, wherein determining the set of one or more Wi-Fi sensing entities from the plurality of Wi-Fi sensing entities for participation in the sensing session is further based on diversity of the plurality of Wi-Fi sensing entities.
Clause 85: The Wi-Fi responding entity of any of clauses 69 to 84, further comprising: means for sending a sensing mode indicator to the Wi-Fi requesting entity, wherein the sensing mode indicator corresponds to location diversity criteria used by the Wi-Fi responding entity to select the set of one or more Wi-Fi sending entities.
Clause 86: The Wi-Fi responding entity of any of clauses 69 to 85, further comprising: means for updating the set of one or more confidence metrics associated with one or more Wi-Fi sensing entities of the plurality of Wi-Fi sensing entities during the sensing session; and means for dynamically adjusting the Wi-Fi sensing entities participating in the sensing session based on the updated set of one or more confidence metrics.
Clause 87: A non-transitory computer-readable medium storing computer-executable instructions that, when executed by a Wi-Fi responding entity, cause the Wi-Fi responding entity to: receive, from a Wi-Fi requesting entity, a sensing-by-proxy request to configure a sensing session to sense a target area; determine a set of one or more Wi-Fi sensing entities from a plurality of Wi-Fi sensing entities for participation in the sensing session based on a set of one or more confidence metrics associated with each Wi-Fi sensing entity of the plurality of Wi-Fi sensing entities, wherein the one or more confidence metrics associated with each Wi-Fi sensing entity is indicative of an ability of the Wi-Fi sensing entity to provide reliable sensing measurements for sensing the target area during the sensing session; and perform an action including at least one of configuring the set of one or more Wi-Fi sensing entities for participation in the sensing session, or sending a sensing report to the Wi-Fi requesting entity indicating the confidence metrics associated with each Wi-Fi sensing entity of the plurality of Wi-Fi sensing entities.
Clause 88: The non-transitory computer-readable medium of clause 87, wherein the sensing-by-proxy request indicates a preferred set of one or more Wi-Fi sensing entity candidates for use during the sensing session.
Clause 89: The non-transitory computer-readable medium of any of clauses 87 to 88, wherein the preferred set of one or more Wi-Fi sensing entities are determined by the Wi-Fi requesting entity from nearby sensing entities based on confidence metrics associated with the nearby sensing entities.
Clause 90: The non-transitory computer-readable medium of any of clauses 87 to 89, wherein the computer-executable instructions, when executed by the Wi-Fi responding entity, cause the Wi-Fi responding entity to determine the set of one or more Wi-Fi sensing entities from the plurality of Wi-Fi sensing entities, and computer-executable instructions, when executed by the Wi-Fi responding entity, further cause the Wi-Fi responding entity to: select the set of one or more Wi-Fi sensing entities from the preferred set of one or more Wi-Fi sensing entity candidates based on the set of one or more confidence metrics associated with each Wi-Fi sensing entity of the preferred set of one or more Wi-Fi sensing entity candidates.
Clause 91: The non-transitory computer-readable medium of any of clauses 87 to 90, wherein the computer-executable instructions, when executed by the Wi-Fi responding entity, cause the Wi-Fi responding entity to determine the set of one or more Wi-Fi sensing entities from the plurality of Wi-Fi sensing entities, and the computer-executable instructions, when executed by the Wi-Fi responding entity, further cause the Wi-Fi responding entity to: select a Wi-Fi sensing entity from the plurality of Wi-Fi sensing entities that is not included in the preferred set of one or more Wi-Fi sensing entity candidates based on an indication in a reserved field of the sensing-by-proxy request.
Clause 92: The non-transitory computer-readable medium of any of clauses 87 to 91, wherein the preferred set of one or more Wi-Fi sensing entity candidates is determined by the Wi-Fi requesting entity based on confidence metrics associated with the one or more Wi-Fi sensing entities; and determining the set of one or more Wi-Fi sensing entities from the plurality of Wi-Fi sensing entities comprises: selecting the set of one or more Wi-Fi sensing entities from the preferred set of one or more Wi-Fi sensing entity candidates based on the set of one or more confidence metrics associated with each Wi-Fi sensing entity of the preferred set of one or more Wi-Fi sensing entity candidates.
Clause 93: The non-transitory computer-readable medium of any of clauses 87 to 92, wherein the sensing-by-proxy request indicates the preferred set of one or more Wi-Fi sensing entity candidates and a mandatory set of one or more Wi-Fi sensing entity candidates to be used during the sensing session.
Clause 94: The non-transitory computer-readable medium of any of clauses 87 to 93, wherein the computer-executable instructions, when executed by the Wi-Fi responding entity, cause the Wi-Fi responding entity to determine the set of one or more Wi-Fi sensing entities from the plurality of Wi-Fi sensing entities, and the computer-executable instructions, when executed by the Wi-Fi responding entity, further cause the Wi-Fi responding entity to: determine the set of one or more Wi-Fi sensing entities based on the preferred set of one or more Wi-Fi sensing entity candidates and a mandatory preferred set of one or more Wi-Fi sensing entity candidates; and send a sensing report to the Wi-Fi requesting entity indicating the confidence metrics associated with each of the set of one or more Wi-Fi sensing entities for use by the Wi-Fi requesting entity in configuring a weight for sensing measurements obtained by each Wi-Fi sensing entity of the set of one or more Wi-Fi sensing entities.
Clause 95: The non-transitory computer-readable medium of any of clauses 87 to 94, further comprising computer-executable instructions that, when executed by the Wi-Fi responding entity, cause the Wi-Fi responding entity to: assign a role to a given Wi-Fi sensing entity of the preferred set of one or more Wi-Fi sensing entity candidates as a sensing transmitter or a sensing receiver based on the one or more confidence metrics associated with the given Wi-Fi sensing entity.
Clause 96: The non-transitory computer-readable medium of any of clauses 87 to 95, wherein the role is assigned to the given Wi-Fi sensing entity of the preferred set of one or more Wi-Fi sensing entity candidates based on an absence of a specific role for the given Wi-Fi sensing being designated in the sensing-by-proxy request.
Clause 97: The non-transitory computer-readable medium of any of clauses 87 to 96, further comprising computer-executable instructions that, when executed by the Wi-Fi responding entity, cause the Wi-Fi responding entity to: periodically update at least one characteristic used to determine at least one confidence metric of at least one Wi-Fi sensing entity of the plurality of Wi-Fi sensing entities.
Clause 98: The non-transitory computer-readable medium of any of clauses 87 to 97, further comprising computer-executable instructions that, when executed by the Wi-Fi responding entity, cause the Wi-Fi responding entity to: send, to a network server, sensing information associated with one or more Wi-Fi sensing entities of the plurality of Wi-Fi sensing entities.
Clause 99: The non-transitory computer-readable medium of any of clauses 87 to 98, further comprising computer-executable instructions that, when executed by the Wi-Fi responding entity, cause the Wi-Fi responding entity to: obtain, from a network server, sensing information associated with the one or more Wi-Fi sensing entities; and the configuring of the set of one or more Wi-Fi sense entities is based, at least in part, on the sensing information obtained from the network server.
Clause 100: The non-transitory computer-readable medium of any of clauses 87 to 99, wherein the set of one or more confidence metrics associated with each Wi-Fi sensing entity is based on: a mobility state of the Wi-Fi sensing entity; an absolute location of the Wi-Fi sensing entity; an estimated location of the Wi-Fi sensing entity; channel conditions associated with the Wi-Fi sensing entity; bandwidth capability of the Wi-Fi sensing entity; transmission power capability of the Wi-Fi sensing entity; processing power capability of the Wi-Fi sensing entity; an error estimate associated with the Wi-Fi sensing entity; Radio Access Technology (RAT) Availability of the Wi-Fi sensing entity, or; and any combination thereof.
Clause 101: The non-transitory computer-readable medium of any of clauses 87 to 100, wherein the set of one or more confidence metrics associated with each Wi-Fi sensing entity is based on: received signal strength indicator (RSSI) measurements of signals received from the Wi-Fi sensing entity at the Wi-Fi responding entity; round-trip time (RTT) measurements of signals transmitted between the Wi-Fi sensing entity and the Wi-Fi responding entity; angle-of-arrival (AoA) measurements of signals transmitted between the Wi-Fi sensing entity and the Wi-Fi responding entity; or any combination thereof.
Clause 102: The non-transitory computer-readable medium of any of clauses 87 to 101, wherein determining the set of one or more Wi-Fi sensing entities from the plurality of Wi-Fi sensing entities for participation in the sensing session is further based on diversity of the plurality of Wi-Fi sensing entities.
Clause 103: The non-transitory computer-readable medium of any of clauses 87 to 102, further comprising computer-executable instructions that, when executed by the Wi-Fi responding entity, cause the Wi-Fi responding entity to: send a sensing mode indicator to the Wi-Fi requesting entity, wherein the sensing mode indicator corresponds to location diversity criteria used by the Wi-Fi responding entity to select the set of one or more Wi-Fi sending entities.
Clause 104: The non-transitory computer-readable medium of any of clauses 87 to 103, further comprising computer-executable instructions that, when executed by the Wi-Fi responding entity, cause the Wi-Fi responding entity to: update the set of one or more confidence metrics associated with one or more Wi-Fi sensing entities of the plurality of Wi-Fi sensing entities during the sensing session; and dynamically adjust the Wi-Fi sensing entities participating in the sensing session based on the updated set of one or more confidence metrics.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general-purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method performed by a Wi-Fi requesting entity, comprising:
determining a set of one or more Wi-Fi sensing entities from a plurality of Wi-Fi sensing entities for participation in a sensing session based on a set of one or more confidence metrics associated with each Wi-Fi sensing entity of the plurality of Wi-Fi sensing entities, wherein the set of one or more confidence metrics associated with each Wi-Fi sensing entity is indicative of an ability of the Wi-Fi sensing entity to provide reliable sensing measurements or sensing signal transmissions for sensing a target area during the sensing session; and
providing an indication of the set of one or more Wi-Fi sensing entities to a Wi-Fi responding entity.

2. The method of claim 1, wherein the providing the indication of the set of one or more Wi-Fi sensing entities to a Wi-Fi responding entity includes sending a sensing-by-proxy request including the indication of the set of one or more Wi-Fi sensing entities to the Wi-Fi responding entity.

3. The method of claim 1, wherein the providing the indication of the set of one or more Wi-Fi sensing entities to the Wi-Fi responding entity includes providing a list of Wi-Fi sensing entities based on the set of one or more confidence metrics associated with each Wi-Fi sensing entity of the set of one or more Wi-Fi sensing entities to the Wi-Fi responding entity.

4. The method of claim 1, wherein the indication of the set of one or more Wi-Fi sensing entities includes an indication of a preferred set of one or more Wi-Fi sensing entity candidates available for selection by the Wi-Fi responding entity.

5. The method of claim 1, wherein the indication of the set of one or more Wi-Fi sensing entities includes an indication of a set of one or more mandatory Wi-Fi sensing entities for configuration by the Wi-Fi responding entity for the sensing session.

6. The method of claim 1, wherein the indication of the set of one or more Wi-Fi sensing entities is indicated by at least a portion of a standardized Medium Access Control Layer Management Entity (MLME) sensing-by-proxy primitive.

7. The method of claim 1, wherein the set of one or more confidence metrics associated with each Wi-Fi sensing entity is based on:
a mobility state of the Wi-Fi sensing entity,
an absolute location of the Wi-Fi sensing entity,
an estimated location of the Wi-Fi sensing entity,
channel conditions between the Wi-Fi requesting entity and the Wi-Fi sensing entity,
bandwidth capability of the Wi-Fi sensing entity,
transmission power capability of the Wi-Fi sensing entity,
processing power capability of the Wi-Fi sensing entity,
an error estimate associated with the Wi-Fi sensing entity,
Radio Access Technology (RAT) Availability of the Wi-Fi sensing entity, or
any combination thereof.

8. The method of claim 1, wherein the set of one or more confidence metrics associated with each Wi-Fi sensing entity is based on:
received signal strength indicator (RSSI) measurements of signals received from the Wi-Fi sensing entity at the Wi-Fi requesting entity,
round-trip time (RTT) measurements of signals transmitted between the Wi-Fi sensing entity and the Wi-Fi requesting entity,
angle-of-arrival (AoA) measurements of signals transmitted between the Wi-Fi sensing entity and the Wi-Fi requesting entity, or any combination thereof.

9. A method performed by a Wi-Fi responding entity, comprising:
receiving, from a Wi-Fi requesting entity, a sensing-by-proxy request to configure a sensing session to sense a target area;
determining a set of one or more Wi-Fi sensing entities from a plurality of Wi-Fi sensing entities for participation in the sensing session based on a set of one or more confidence metrics associated with each Wi-Fi sensing entity of the plurality of Wi-Fi sensing entities, wherein the one or more confidence metrics associated with each Wi-Fi sensing entity is indicative of an ability of the Wi-Fi sensing entity to provide reliable sensing measurements for sensing the target area during the sensing session; and
performing an action including at least one of
configuring the set of one or more Wi-Fi sensing entities for participation in the sensing session, or
sending a sensing report to the Wi-Fi requesting entity indicating the confidence metrics associated with each Wi-Fi sensing entity of the plurality of Wi-Fi sensing entities.

10. The method of claim 9, wherein the sensing-by-proxy request indicates a preferred set of one or more Wi-Fi sensing entity candidates for use during the sensing session.

11. The method of claim 10, wherein the preferred set of one or more Wi-Fi sensing entities are determined by the Wi-Fi requesting entity from nearby sensing entities based on confidence metrics associated with the nearby sensing entities.

12. The method of claim 10, wherein determining the set of one or more Wi-Fi sensing entities from the plurality of Wi-Fi sensing entities, comprises:
selecting the set of one or more Wi-Fi sensing entities from the preferred set of one or more Wi-Fi sensing entity candidates based on the set of one or more confidence metrics associated with each Wi-Fi sensing entity of the preferred set of one or more Wi-Fi sensing entity candidates.

13. The method of claim 10, wherein determining the set of one or more Wi-Fi sensing entities from the plurality of Wi-Fi sensing entities further comprises:
selecting a Wi-Fi sensing entity from the plurality of Wi-Fi sensing entities that is not included in the preferred set of one or more Wi-Fi sensing entity candidates based on an indication in a reserved field of the sensing-by-proxy request.

14. The method of claim 10, wherein the preferred set of one or more Wi-Fi sensing entity candidates is determined by the Wi-Fi requesting entity based on confidence metrics associated with the one or more Wi-Fi sensing entities; and
determining the set of one or more Wi-Fi sensing entities from the plurality of Wi-Fi sensing entities comprises:
selecting the set of one or more Wi-Fi sensing entities from the preferred set of one or more Wi-Fi sensing entity candidates based on the set of one or more confidence metrics associated with each Wi-Fi sensing entity of the preferred set of one or more Wi-Fi sensing entity candidates.

15. The method of claim 10, wherein the sensing-by-proxy request indicates the preferred set of one or more Wi-Fi sensing entity candidates and a mandatory set of one or more Wi-Fi sensing entity candidates to be used during the sensing session.

16. The method of claim 15, wherein determining the set of one or more Wi-Fi sensing entities from the plurality of Wi-Fi sensing entities comprises:
determining the set of one or more Wi-Fi sensing entities based on the preferred set of one or more Wi-Fi sensing entity candidates and a mandatory preferred set of one or more Wi-Fi sensing entity candidates; and
the method further comprises:
sending a sensing report to the Wi-Fi requesting entity indicating the confidence metrics associated with each of the set of one or more Wi-Fi sensing entities for use by the Wi-Fi requesting entity in configuring a weight for sensing measurements obtained by each Wi-Fi sensing entity of the set of one or more Wi-Fi sensing entities.

17. The method of claim 10, further comprising:
assigning a role to a given Wi-Fi sensing entity of the preferred set of one or more Wi-Fi sensing entity candidates as a sensing transmitter or a sensing receiver based on the one or more confidence metrics associated with the given Wi-Fi sensing entity.

18. The method of claim 17, wherein the role is assigned to the given Wi-Fi sensing entity of the preferred set of one or more Wi-Fi sensing entity candidates based on an absence of a specific role for the given Wi-Fi sensing being designated in the sensing-by-proxy request.

19. The method of claim 9, further comprising:
periodically updating at least one characteristic used to determine at least one confidence metric of at least one Wi-Fi sensing entity of the plurality of Wi-Fi sensing entities.

20. The method of claim 9, further comprising:
sending, to a network server, sensing information associated with one or more Wi-Fi sensing entities of the plurality of Wi-Fi sensing entities.

21. The method of claim 9, further comprising:
obtaining, from a network server, sensing information associated with the one or more Wi-Fi sensing entities; and
the configuring of the set of one or more Wi-Fi sensing entities based, at least in part, on the sensing information obtained from the network server.

22. The method of claim 9, wherein the set of one or more confidence metrics associated with each Wi-Fi sensing entity is based on:
a mobility state of the Wi-Fi sensing entity,
an absolute location of the Wi-Fi sensing entity,
an estimated location of the Wi-Fi sensing entity,
channel conditions associated with the Wi-Fi sensing entity,
bandwidth capability of the Wi-Fi sensing entity,
transmission power capability of the Wi-Fi sensing entity,
processing power capability of the Wi-Fi sensing entity,
an error estimate associated with the Wi-Fi sensing entity,
Radio Access Technology (RAT) Availability of the Wi-Fi sensing entity, or
any combination thereof.

23. The method of claim 9, wherein the set of one or more confidence metrics associated with each Wi-Fi sensing entity is based on:
received signal strength indicator (RSSI) measurements of signals received from the Wi-Fi sensing entity at the Wi-Fi responding entity;
round-trip time (RTT) measurements of signals transmitted between the Wi-Fi sensing entity and the Wi-Fi responding entity;
angle-of-arrival (AoA) measurements of signals transmitted between the Wi-Fi sensing entity and the Wi-Fi responding entity; or
any combination thereof.

24. The method of claim 9, wherein determining the set of one or more Wi-Fi sensing entities from the plurality of Wi-Fi sensing entities for participation in the sensing session is further based on diversity of the plurality of Wi-Fi sensing entities.

25. The method of claim 24, further comprising:
sending a sensing mode indicator to the Wi-Fi requesting entity, wherein the sensing mode indicator corresponds to location diversity criteria used by the Wi-Fi responding entity to select the set of one or more Wi-Fi sending entities.

26. The method of claim 9, further comprising:
updating the set of one or more confidence metrics associated with one or more Wi-Fi sensing entities of the plurality of Wi-Fi sensing entities during the sensing session; and
dynamically adjusting the Wi-Fi sensing entities participating in the sensing session based on the updated set of one or more confidence metrics.

27. A Wi-Fi requesting entity, comprising:
one or more memories;
one or more transceivers; and
one or more processors communicatively coupled to the one or more memories and the one or more transceivers, the one or more processors, either alone or in combination, configured to:
determine a set of one or more Wi-Fi sensing entities from a plurality of Wi-Fi sensing entities for participation in a sensing session based on a set of one or more confidence metrics associated with each Wi-Fi sensing entity of the plurality of Wi-Fi sensing entities, wherein the set of one or more confidence metrics associated with each Wi-Fi sensing entity is indicative of an ability of the Wi-Fi sensing entity to provide reliable sensing measurements or sensing signal transmissions for sensing a target area during the sensing session; and
provide an indication of the set of one or more Wi-Fi sensing entities to a Wi-Fi responding entity.

28. The Wi-Fi requesting entity of claim 27, wherein providing the indication of the set of one or more Wi-Fi sensing entities to the Wi-Fi responding entity includes sending a sensing-by-proxy request including the indication of the set of one or more Wi-Fi sensing entities to the Wi-Fi responding entity.

29. The Wi-Fi requesting entity of claim 27, wherein providing the indication of the set of one or more Wi-Fi sensing entities to the Wi-Fi responding entity includes providing a list of Wi-Fi sensing entities based on the set of one or more confidence metrics associated with each Wi-Fi sensing entity of the set of one or more Wi-Fi sensing entities to the Wi-Fi responding entity.

30. The Wi-Fi requesting entity of claim 27, wherein the indication of the set of one or more Wi-Fi sensing entities includes an indication of a preferred set of one or more Wi-Fi sensing entity candidates available for selection by the Wi-Fi responding entity.

31. The Wi-Fi requesting entity of claim 27, wherein the indication of the set of one or more Wi-Fi sensing entities includes an indication of a set of one or more mandatory Wi-Fi sensing entities for configuration by the Wi-Fi responding entity for the sensing session.

32. The Wi-Fi requesting entity of claim 27, wherein the indication of the set of one or more Wi-Fi sensing entities is indicated by at least a portion of a standardized Medium Access Control Layer Management Entity (MLME) sensing-by-proxy primitive.

33. The Wi-Fi requesting entity of claim 27, wherein the set of one or more confidence metrics associated with each Wi-Fi sensing entity is based on:
a mobility state of the Wi-Fi sensing entity;
an absolute location of the Wi-Fi sensing entity;
an estimated location of the Wi-Fi sensing entity;
channel conditions between the Wi-Fi requesting entity and the Wi-Fi sensing entity;
bandwidth capability of the Wi-Fi sensing entity;
transmission power capability of the Wi-Fi sensing entity;
processing power capability of the Wi-Fi sensing entity;
an error estimate associated with the Wi-Fi sensing entity;
Radio Access Technology (RAT) Availability of the Wi-Fi sensing entity, or; and
any combination thereof.

34. The Wi-Fi requesting entity of claim 27, wherein the set of one or more confidence metrics associated with each Wi-Fi sensing entity is based on:
received signal strength indicator (RSSI) measurements of signals received from the Wi-Fi sensing entity at the Wi-Fi requesting entity;
round-trip time (RTT) measurements of signals transmitted between the Wi-Fi sensing entity and the Wi-Fi requesting entity;
angle-of-arrival (AoA) measurements of signals transmitted between the Wi-Fi sensing entity and the Wi-Fi requesting entity, or; and
any combination thereof.

35. A Wi-Fi responding entity, comprising:
one or more memories;
one or more transceivers; and
one or more processors communicatively coupled to the one or more memories and the one or more transceivers, the one or more processors, either alone or in combination, configured to:
receive, from a Wi-Fi requesting entity, a sensing-by-proxy request to configure a sensing session to sense a target area;
determine a set of one or more Wi-Fi sensing entities from a plurality of Wi-Fi sensing entities for participation in the sensing session based on a set of one or more confidence metrics associated with each Wi-Fi sensing entity of the plurality of Wi-Fi sensing entities, wherein the one or more confidence metrics associated with each Wi-Fi sensing entity is indicative of an ability of the Wi-Fi sensing entity to provide reliable sensing measurements for sensing the target area during the sensing session; and
perform an action including at least one of
configure the set of one or more Wi-Fi sensing entities for participation in the sensing session, or
send a sensing report to the Wi-Fi requesting entity indicating the confidence metrics associated with each Wi-Fi sensing entity of the plurality of Wi-Fi sensing entities.

36. The Wi-Fi responding entity of claim 35, wherein the sensing-by-proxy request indicates a preferred set of one or more Wi-Fi sensing entity candidates for use during the sensing session.

37. The Wi-Fi responding entity of claim 36, wherein the preferred set of one or more Wi-Fi sensing entities are determined by the Wi-Fi requesting entity from nearby sensing entities based on confidence metrics associated with the nearby sensing entities.

38. The Wi-Fi responding entity of claim 36, wherein the one or more processors, when determining the set of one or more Wi-Fi sensing entities from the plurality of Wi-Fi sensing entities, are configured to:
select the set of one or more Wi-Fi sensing entities from the preferred set of one or more Wi-Fi sensing entity candidates based on the set of one or more confidence metrics associated with each Wi-Fi sensing entity of the preferred set of one or more Wi-Fi sensing entity candidates.

39. The Wi-Fi responding entity of claim 36, wherein the one or more processors, when determining the set of one or more Wi-Fi sensing entities from the plurality of Wi-Fi sensing entities, are configured to:
select a Wi-Fi sensing entity from the plurality of Wi-Fi sensing entities that is not included in the preferred set of one or more Wi-Fi sensing entity candidates based on an indication in a reserved field of the sensing-by-proxy request.

40. The Wi-Fi responding entity of claim 36, wherein the preferred set of one or more Wi-Fi sensing entity candidates is determined by the Wi-Fi requesting entity based on confidence metrics associated with the one or more Wi-Fi sensing entities; and
determining the set of one or more Wi-Fi sensing entities from the plurality of Wi-Fi sensing entities comprises:
selecting the set of one or more Wi-Fi sensing entities from the preferred set of one or more Wi-Fi sensing entity candidates based on the set of one or more confidence metrics associated with each Wi-Fi sensing entity of the preferred set of one or more Wi-Fi sensing entity candidates.

41. The Wi-Fi responding entity of claim 36, wherein the sensing-by-proxy request indicates the preferred set of one or more Wi-Fi sensing entity candidates and a mandatory set of one or more Wi-Fi sensing entity candidates to be used during the sensing session.

42. The Wi-Fi responding entity of claim 41, wherein the one or more processors, when determining the set of one or more Wi-Fi sensing entities from the plurality of Wi-Fi sensing entities, are configured to:
determine the set of one or more Wi-Fi sensing entities based on the preferred set of one or more Wi-Fi sensing entity candidates and a mandatory preferred set of one or more Wi-Fi sensing entity candidates; and
the one or more processors either alone in combination are further configured to:
send a sensing report to the Wi-Fi requesting entity indicating the confidence metrics associated with each of the set of one or more Wi-Fi sensing entities for use by the Wi-Fi requesting entity in configuring a weight for sensing measurements obtained by each Wi-Fi sensing entity of the set of one or more Wi-Fi sensing entities.

43. The Wi-Fi responding entity of claim 36, wherein the one or more processors, either alone or in combination, are further configured to:
assign a role to a given Wi-Fi sensing entity of the preferred set of one or more Wi-Fi sensing entity candidates as a sensing transmitter or a sensing receiver based on the one or more confidence metrics associated with the given Wi-Fi sensing entity.

44. The Wi-Fi responding entity of claim 43, wherein the role is assigned to the given Wi-Fi sensing entity of the preferred set of one or more Wi-Fi sensing entity candidates based on an absence of a specific role for the given Wi-Fi sensing being designated in the sensing-by-proxy request.

45. The Wi-Fi responding entity of claim 35, wherein the one or more processors, either alone or in combination, are further configured to:
periodically update at least one characteristic used to determine at least one confidence metric of at least one Wi-Fi sensing entity of the plurality of Wi-Fi sensing entities.

46. The Wi-Fi responding entity of claim 35, wherein the one or more processors, either alone or in combination, are further configured to:
send, to a network server, sensing information associated with one or more Wi-Fi sensing entities of the plurality of Wi-Fi sensing entities.

47. The Wi-Fi responding entity of claim 35, wherein the one or more processors, either alone or in combination, are further configured to:
obtain, from a network server, sensing information associated with the one or more Wi-Fi sensing entities; and
configuring of the set of one or more Wi-Fi sense entities based, at least in part, on the sensing information obtained from the network server.

48. The Wi-Fi responding entity of claim 35, wherein the set of one or more confidence metrics associated with each Wi-Fi sensing entity is based on:
a mobility state of the Wi-Fi sensing entity;
an absolute location of the Wi-Fi sensing entity;
an estimated location of the Wi-Fi sensing entity;
channel conditions associated with the Wi-Fi sensing entity;
bandwidth capability of the Wi-Fi sensing entity;
transmission power capability of the Wi-Fi sensing entity;
processing power capability of the Wi-Fi sensing entity;
an error estimate associated with the Wi-Fi sensing entity;
Radio Access Technology (RAT) Availability of the Wi-Fi sensing entity, or; and
any combination thereof.

49. The Wi-Fi responding entity of claim 35, wherein the set of one or more confidence metrics associated with each Wi-Fi sensing entity is based on:
received signal strength indicator (RSSI) measurements of signals received from the Wi-Fi sensing entity at the Wi-Fi responding entity;
round-trip time (RTT) measurements of signals transmitted between the Wi-Fi sensing entity and the Wi-Fi responding entity;
angle-of-arrival (AoA) measurements of signals transmitted between the Wi-Fi sensing entity and the Wi-Fi responding entity; or
any combination thereof.

50. The Wi-Fi responding entity of claim 35, wherein determining the set of one or more Wi-Fi sensing entities from the plurality of Wi-Fi sensing entities for participation in the sensing session is further based on diversity of the plurality of Wi-Fi sensing entities.

51. The Wi-Fi responding entity of claim 50, wherein the one or more processors, either alone or in combination, are further configured to:
send a sensing mode indicator to the Wi-Fi requesting entity, wherein the sensing mode indicator corresponds to location diversity criteria used by the Wi-Fi responding entity to select the set of one or more Wi-Fi sending entities.

52. The Wi-Fi responding entity of claim 35, wherein the one or more processors, either alone or in combination, are further configured to:
update the set of one or more confidence metrics associated with one or more Wi-Fi sensing entities of the plurality of Wi-Fi sensing entities during the sensing session; and
dynamically adjust the Wi-Fi sensing entities participating in the sensing session based on the updated set of one or more confidence metrics.
